(19) United States
(12) Patent Application Publication
(10) Pub. No.: US 2023/0385832 A1
(43) Pub. Date: Nov. 30, 2023

(54) CONSERVING COMPUTING RESOURCES DURING IDENTITY VALIDATION VIA A LAST USED ACCOUNT

(71) Applicant: MASTERCARD INTERNATIONAL INCORPORATED, PURCHASE, NY (US)

(72) Inventors: Michael D. McCARTHY, Denver, CO (US); Harjender SINGH, Singapore (SG); Holger KUNKAT, Neumuenster (DE); Tomasz BLACHOWICZ, Lodz (PL); Edward Neil LIVINGSTON, Dunfermline (GB); Krunal BHAYANI, Union City, NJ (US); Maurice David LISCIA, Long Island City, NY (US); Manu Dharmaiah KALLUGUDDE, Jersey City, NJ (US); Pablo FOUREZ, Harrison, NY (US)

(21) Appl. No.: 18/190,086

(22) Filed: Mar. 25, 2023

Related U.S. Application Data
(60) Provisional application No. 63/347,532, filed on May 31, 2022.

(51) Int. Cl. G06Q 20/40; G06Q 20/38

(52) U.S. Cl. CPC G06Q 20/40145; G06Q 20/382

(57) ABSTRACT

Examples provide consumer identity validation (CIV) via last used payment card, improving management of payment infrastructure resources. Examples enable the consumer to more efficiently complete CIV via at least one of a last used account or a last used card. By not requiring consumers to repeatedly go through the entire CIV process at each transaction at the same merchant when using the exact same card they used on a previous visit, excessive and unnecessary strain on the infrastructure is reduced, preventing degradation of the infrastructure. This enables allocating fewer computing resources to CIV, making deployments utilizing low-power or otherwise constrained equipment simpler and easier to maintain. Thus, scaling is enhanced. Individual CIV performance is more efficient, and less computing resources and energy are required across the entire infrastructure. A greater number of CIV transactions are executable in parallel, reducing transaction processing delays, bolstering stability, and reducing error rates.

### BACKGROUND

Traditional mechanisms and techniques for enabling consumers to complete financial transactions at a merchant via a payment card, either online or in person, are not configured to properly manage available payment infrastructure resources given that most consumers who repeatedly frequent the same merchant tend to use the same payment card (also called a “card”) to complete a purchase transaction at each visit. Traditional, contemporary mechanisms and techniques are not configured to account for this usage pattern, and instead force consumers to repeatedly perform consumer identity validation (CIV) and select the same card to complete each purchase transaction upon every visit to the same merchant.

The requirement, inherent in traditional, contemporary payment processing and CIV mechanisms and techniques, that consumers repeatedly go through the entire CIV process at each transaction at the same merchant, even when using the exact same card they used on previously visiting that merchant, places and excessive and unnecessary strain on payment processing infrastructure. This infrastructure is degraded by, e.g.: (1) over-allocation of resources to CIV, especially for deployments using low-power or otherwise performance constrained equipment; and (2) overuse of available resources through requiring a repeat of the entire CIV process at every transaction as described above. The second impact is especially deleterious to the performance of payment processing infrastructure, both at the individual transaction and holistic level by reducing scaling potential. By requiring more resources to complete each individual transaction, each individual transaction takes more computing resources and energy (e.g., electrical power), increasing the cost per transaction. At a holistic level, when each individual CIV transaction requires more resources, fewer CIV transactions are executable in parallel. Because scaling is thus restricted, delays and an increased risk of instability and error are introduced across the entire payment infrastructure.

Compounding this, there is no manual (e.g., pen-and-paper) mechanism or technique available to substitute for traditional, contemporary payment processing and CIV infrastructure impacted and degraded as described above.

### SUMMARY

Some examples provide a computerized method for consumer identity validation (“CIV,” or customer identity validation) for Secure Remote Commerce (herein, “SRC”) via a last used card. The computerized method includes receiving, by a processor, a user identifier associated with a payment request from a user; sending, by the processor, the received user identifier to a plurality of SRC providers; receiving, by the processor, a plurality of SRC responses from the plurality of SRC providers, wherein each SRC response includes a last used account timestamp; determining, by the processor, a target SRC response of the plurality of SRC responses that has a most recent last used account timestamp; and initiating, by the processor, processing of the payment request using a target SRC provider associated with the determined target SRC response and an account identifier associated with the most recent last used account timestamp of the determined target SRC response.

This Summary is provided to introduce a selection of concepts in a simplified form that are further described below in the Detailed Description. The foregoing Summary, as well as the following Detailed Description, including certain examples, will be better understood when read in conjunction with the appended drawings. This Summary is not intended to identify key features or essential features of the claimed subject matter, nor is it intended to be used as an aid in determining the scope of the claimed subject matter.

### BRIEF DESCRIPTION OF THE DRAWINGS

These and other features, aspects, and advantages of the present disclosure will become better understood when the following detailed description is read with reference to the accompanying drawings, wherein:

FIG. 1 is a block diagram illustrating an example of a system for consumer identity validation for secure remote commerce (SRC) via a last used card;

FIG. 2 is a flow diagram illustrating an example of a first pop-up experience for consumer identity validation for SRC via a last used card;

FIG. 3 is a flow diagram illustrating an example of a first embedded experience for consumer identity validation for SRC via a last used card;

FIG. 4 is a flow diagram illustrating an example of a second embedded experience for consumer identity validation for SRC via a last used card;

FIG. 5 is a flow diagram illustrating an example of a Digital Payment Application (DPA)/SRC Initiator (SRCi)-hosted user interface experience for consumer identity validation for SRC via a last used card;

FIG. 6 is a flow diagram illustrating an example of a third embedded experience for a recognized user for consumer identity validation for SRC via a last used card;

FIG. 7 is flow chart illustrating a computerized method for consumer identity validation via a last used card; and

FIG. 8 is an exemplary block diagram illustrating an operating environment.

Corresponding reference characters indicate corresponding parts throughout the drawings. Some figures illustrate systems as schematic drawings. In such figures, the drawings may not be to scale.

### DETAILED DESCRIPTION

Referring to the figures, examples of the disclosure include systems, methods, and computer readable media for consumer identity validation (CIV) for Secure Remote Commerce (SRC) via a last used identifier, account, or card (e.g., a “payment card”).

The systems, methods, and computer readable media disclosed herein provide CIV via at least one of a last used account or a last used card, enabling consumers to complete financial transactions at a merchant via a payment card such that available payment infrastructure resources (the “infrastructure”) are managed to reduce excessive and unnecessary strain on that infrastructure. The disclosed systems, methods, and computer readable media are configured to take into account that most consumers who repeatedly frequent the same merchant tend to use the same payment card (also called a “card”) to complete a purchase transaction at each visit, by enabling the consumer to more efficiently complete CIV during a transaction via at least one of a last used account or a last used card.

By not requiring consumers to repeatedly go through the entire CIV process at each transaction at the same merchant, even when using the exact same card they used on previously visiting that merchant, excessive and unnecessary strain on the infrastructure is reduced, preventing degradation of the infrastructure. Because fewer computing resources need be allocated to CIV, deployments utilizing low-power or otherwise constrained equipment are simpler to implement and easier to maintain. Further, because overuse of the infrastructure is reduced, scaling across the entire infrastructure is enhanced. The infrastructure, both at the individual transaction and holistic level, performs more efficiently both at the level of each individual CIV transaction, which needs less computing resources and energy (e.g., electrical power), and across the entire infrastructure, where at a holistic level, each individual CIV transaction requires fewer resources, enabling the execution of a greater number of CIV transactions in parallel. This increased scalability further reduces CIV transaction processing delays, bolsters stability of the infrastructure, and reduces error rates.

In some examples, as part of the current checkout experience, the consumer is shown the last payment card used by the same consumer at previous checkout experiences at the same merchant. Consumers avoid having to repeatedly select the same card to complete each purchase transaction upon every visit to the same merchant. Thus, consumers are not subjected to additional and unnecessary friction, inconvenience, and inefficiency associated with traditional mechanisms for consumer identity validation.

The disclosed examples thus reduce the real business risks of traditional consumer identity validation associated with long term infliction upon consumers of unnecessary friction, inconvenience, annoyance, and inefficiency. As non-limiting examples, the risk of financial damage to the merchant not only through potential loss of the repeat business of existing customers, but also through reputational damage that costs the merchant potential new business is reduced. Those entities (e.g., merchants, etc.) relying on the disclosed examples are at far less risk becoming known for a slow, inefficient, and cumbersome purchase transaction completion process and enduring financial consequences. Thus, such entities also avoid giving their competitors undue opportunity to flourish at the entities' expense.

Improving the performance of SRC-based solutions for consumers streamlines the consumer experience. The disclosed examples determine a target SRC response based on the target SRC response having a most recent last used account timestamp and automatically initiate processing of the payment request using the associated SRC provider and account of the determined target SRC response, allowing a consumer to complete identity validation faster, and thus to complete the entire checkout experience faster. In many examples disclosed herein, the consumer will have no need to search for a specific, preferred card in a card list during identity verification, since in such examples the consumer is able to automatically re-use the last card used.

Additionally, ameliorating unnecessary friction, inconvenience, annoyance, and inefficiency associated with traditional consumer identity validation mechanisms is expected to enhance the adoption of modern payment systems, bringing the benefits of such systems to merchants, consumers, and the public at an accelerated rate.

Traditional, existing alternatives neither recognize nor account for this reality of consumer behavior. In examples of traditional existing alternatives, consumer cardholders are forced to interact with an SRC system to complete their payment transaction in a way that is both inefficient and error-prone (e.g., a user must provide a high number of user inputs, increasing the likelihood of an error requiring the process be restarted), including in some examples:
The consumer, interacting with a payment network using a Digital Shopping Application (DSA), starts the process of using an SRC system to pay a merchant, via interaction with at least one of a Secure Remote Commerce Initiator (SRCi) and Digital Card Facilitator (DCF);
Where the consumer is not recognized on the DSA (e.g., no cookie is present), at least one of the SRCi and DCF contacts the SRC providers associated with all available payment networks to see which one(s) the consumer has account with, using information unique to the consumer as identification (e.g., consumer phone, consumer email, etc.);
Each of the various SRC providers respond that the consumer either does or does not have an account associated with that SRC provider;
The SRCi chooses the SRC provider that responds the fastest that the consumer does have an at least one account associated with the SRC provider;
At least one of the SRC, SRCi, DSA, and DCF complete the validation by at least:
   Instructing the SRC provider to start validation,
   SRC sends one-time password (OTP) to the consumer (e.g., via the consumer email, consumer phone, etc.),
   The consumer enters the provided OTP into a user interface associated with the SRCi,
   The SRCi sends the completed consumer validation to the chosen SRC,
   The chosen SRC validates the consumer (e.g., using an identity token, etc.),
   The SRCi receives this proof of an authenticated customer (e.g., using an identity token, etc.),
   Using this proof, the SRCi contacts all entities associated with the chosen SRC having available payment cards, the SRCi receiving the list of available payment cards from the chosen SRC, and
   The SRCi displays the list to the consumer via a user interface (e.g., using at least a DCF) enabling the consumer to select a payment card from the list;

The failings of such traditional, existing alternatives are readily apparent. Such failings include but are not limited to:
By always selecting the SRC with the fastest response, even if that SRC is not associated with the originating payment network, it is possible and even likely that an SRC associated with a competing payment network to the originating payment network will be chosen.
In such cases, user interface elements, including but not limited to those associated with collecting the OTP, display the branding of competitor(s) to the originating payment network.
Traditional, existing alternatives thus do not take any consideration at all of whether a consumer ever actually uses a payment card associated with the chosen SRC before selecting the chosen SRC.
Traditional, existing alternatives support providing an OTP only via Short Message Service, e-mail; out-of-band OTP (e.g., an OTP process where the password is sent via a channel that separate from the channel used for the transaction) is not supported.

The elements described herein in various examples operate in an unconventional manner to provide consumer identity validation for SRC via a last used card by recognizing and accounting for the reality that most consumers who repeatedly frequent the same merchant tend to use the same card to complete a purchase transaction at each visit. The failings of the traditional, existing alternatives, including those failings discussed herein above, are avoided and rendered moot by the SRCi choosing the SRC provider that reports having the most recently used card associated with the consumer. Such reporting is accomplished by, e.g., indicating the last used time with a timestamp. The examples described herein thus operate in an unconventional manner at least by: the SRCi waiting for all SRC providers to respond, the SRCi retrieving the necessary information about all available SRC providers, and the SRCi then analyzing that information to choose the SRC provider associated with the most recently used or last used card. In some such examples, the slowest SRC provider is chosen when the slowest SRC provider reports being associated with the payment card having the most recent last used card timestamp.

By choosing the SRC provider associated with the most recently used or last used card, the consumer experience is improved and made less confusing by enabling the consumer to easily and consistently interact with the same SRC system that manages the payment card that the consumer used last. By contrast, traditional, existing alternatives often inflict upon the consumer confusion and inconvenience. This is because traditional, existing alternatives, in some examples, force the consumer to interact with an SRC system that is not the SRC system managing the payment card that the consumer used last.

Further, some examples demonstrate additional operation in an unconventional manner at least by choosing an SRC provider based at least in part on at least one of: (1) calculation of a score relative to other non-chosen SRC providers; (2) application of a set of rules to the information reported by all the SRC providers; or (3) other similar weight-based decision-making techniques. In such examples, the SRC providers store and report such information back to the SRCi on request. This information is then usable to identify a pattern of use of a consumer. In some such examples, the SRCi makes such decisions—for example, by determining that e-commerce purchases should use one particular card, and non-e-commerce purchases should use another specific card.

The disclosure is thus more effective than traditional, existing alternatives, and more economical to implement. The disclosure provides consumer identity validation for secure remote commerce via a last used card. Thus, from the perspective of both consumers and merchants utilizing the disclosed examples, payment transactions are completed with less friction and less annoyance, more convenience and more efficiency, when contrasted to traditional, existing alternative consumer identity validation mechanisms and techniques. The disclosed examples of consumer identity validation additionally operate in an unconventional manner to enhance the adoption of modern payment systems, bringing the benefits of such systems to merchants, consumers, and the public at an accelerated rate.

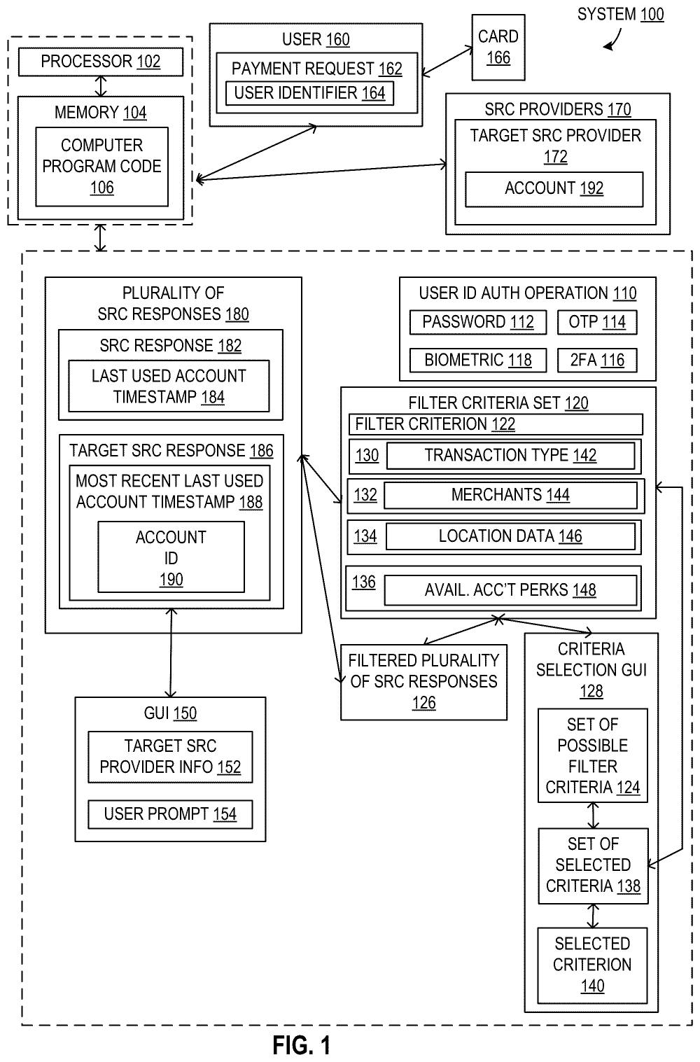

Referring to FIG. 1, a block diagram illustrates an example of a system 100 for consumer identity validation for SRC via a last used card 166. In some examples, the system 100 is a computer, a server, a distributed system, a web server, a database, a mobile device, a communication device, a desktop computer, a laptop, a tablet computer, a point of sale (POS) system, or a combination thereof. The system 100 comprises at least one processor 102 and at least one memory 104. The memory 104 comprises computer program code 106. The memory 104 and the computer program code 106 are configured to, with the processor 102, cause the processor 102 perform operations.

The processor 102 receives a user identifier 164 associated with a payment request 162 from a user 160. In examples herein, the user identifier 164 is any data suitable to differentiate the user 160 from every other user. The user identifier 164 enables differentiating the user 160 from every other user even in examples where the user 160 and at least one of every other user share at least some of the same personal data (e.g., name, date of birth, etc.). Some non-exclusive examples of the user identifier 164 are provided herein as part of the “Additional Examples” subsection, below.

In some examples, the user 160 is a consumer. The processor 102 sends the received user identifier 164 to a plurality of Secure Remote Commerce (SRC) providers 170. Further, in some examples, the received user identifier 164 is sent to the plurality of SRC providers 170 to facilitate the performance of CIV operations. Alternatively, or additionally, in some examples, the received user identifier 164 is sent to a plurality of CIV providers that includes more, fewer, and/or different providers than the plurality of SRC providers without departing from the description. From the plurality of SRC providers 170, the processor 102 receives a plurality of SRC responses 180. Each SRC response 182 of the plurality of SRC responses 180 includes at least a last used account timestamp 184. Each last used account timestamp 184 comprises a record of the time the user 160 last used a payment card linked to an account 192 associated with the SRC provider 170 that submitted the SRC response 182 to complete a purchase transaction. In some such examples, the record of the time comprises a particular time and date, the particular time and date being formatted such that the particular time and date is comparable to another time and date to determine a chronology of at least two last used timestamps 184, enabling the processor to determine which of the at least two last used timestamps 184 is more recent. Such last use, in some examples, comprises the user 160 having used a payment card available for use through the associated SRC provider 170.

The processor 102 determines a target SRC response 186 of the plurality of SRC responses 180. The target SRC response 186 comprises a most recent last used account timestamp 188. The most recent last used account timestamp 188 comprises the most recent of each of the last used timestamps 184 associated with the plurality of SRC responses 182.

Having determined the target SRC response 186, the processor 102 initiates processing of the payment request 162 using a target SRC provider 172. The target SRC provider 172 is associated with the determined target SRC response 186 and an account identifier 190 associated with the most recent last used account timestamp 188 of the determined target SRC response 186. In some examples, initiating processing of the payment request 162 further includes performing a user identity authentication operation 110. Some examples of the user identity authentication operation 110 include at least one of the following:
user authentication using a password 112,
user authentication using a one-time password (OTP) 114,
user authentication using two-factor authentication (2FA) 116, and
user authentication using biometric authentication 118.

Other examples of the user identity authentication operation 110 use at least one of any other authentication technique, now known or not yet known, suitable for use in place of to achieve the same results as the non-limiting examples of the user identity authentication operation 110 disclosed above in this paragraph.

In some examples, the memory 104 and the computer program code 106 are further configured to, with the processor 102, cause the processor 102 to filter the received plurality of SRC responses 180. The filtering uses a filter criteria set 120. The filter criteria set 120 includes at least one filter criterion 122. In such examples, determining the target SRC response 186 of the plurality of SRC responses 180 includes determining the target SRC response 186 of a filtered plurality of SRC responses 126, where the determined target SRC response 186 has the most recent last used account timestamp 188. In some such examples, the filter criteria set 120 includes at least one of the following:
a first filter criterion 130 based on transaction types 142 associated with the last used account timestamps 184;
a second filter criterion 132 based on merchants 144 associated with the last used account timestamps 184;
a third filter criterion 134 based on location data 146 associated with the last used account timestamps 184; and
a fourth filter criterion 136 based on available account perks 148 of accounts 192 associated with the last used account timestamps.

In some other such examples, the filter criterion set 120 includes only one filter criterion 122 or at least one filter criterion 122.

In some such examples, the processor 102 prompts the user 160 to select the filter criteria set 120 from a set of possible filter criteria 124 using a criteria selection Graphical User Interface (GUI) 128. The processor 102 receives a set of selected criteria 138 from the criteria selection GUI 128. The set of selected criteria 138 includes at least one selected criterion 140. The processor 102 defines the filter criteria set 120 using the received set of selected criteria 138.

Further, in some examples, a transaction type filter criterion is used to filter the received plurality of SRC responses 180 such that the target SRC response 186 is selected from the filtered plurality of SRC responses 126 which includes SRC responses 182 that include last used account timestamps 184 associated with transactions of a transaction type that matches a transaction type associated with the payment request 162.

Additionally, or alternatively, a merchant filter criterion is used to filter the SRC responses 182 such that the target SRC response 186 is selected from the filtered plurality of SRC responses 126, which includes SRC responses that include last used account timestamps 184 associated with transactions at a merchant that matches the merchant associated with the payment request 162.

Further, in some examples, a location filter criterion is used to filter the SRC responses 182 such that the target SRC response 186 is selected from the filtered plurality of SRC responses 126 which includes SRC responses 182 that include last used account timestamps 184 associated with a location that matches or is within proximity to a location associated with the payment request 162.

Additionally, or alternatively, an account perks filter criterion is used to filter the SRC responses 182 such that the target SRC response 186 is selected from the filtered plurality of SRC responses 126 which includes SRC responses 182 that include last used account timestamps 184 associated with accounts that offer account perks for the payment request 162.

In other examples, more, fewer, or different filter criteria are used to filter the SRC responses without departing from the description herein.

In some examples, initiating processing of the payment request 162 by the processor 102 further includes at least: displaying information 152. The information 152 is associated with the target SRC provider 172 of the determined target SRC response 186. The information is displayed using a GUI 150. In such examples, the processor 102, using the GUI 150, further prompts the user 160 via a user prompt 154 to confirm use of an account 192 identified by the account identifier 190. The account identifier 190 is associated with the most recent last used account timestamp 188. The processor 102 receives confirmation to use the account 192 from the user 160 using the GUI 150. After confirmation, the processor 102 completes processing of the payment request 162 using the account 192 confirmed by the user 160.

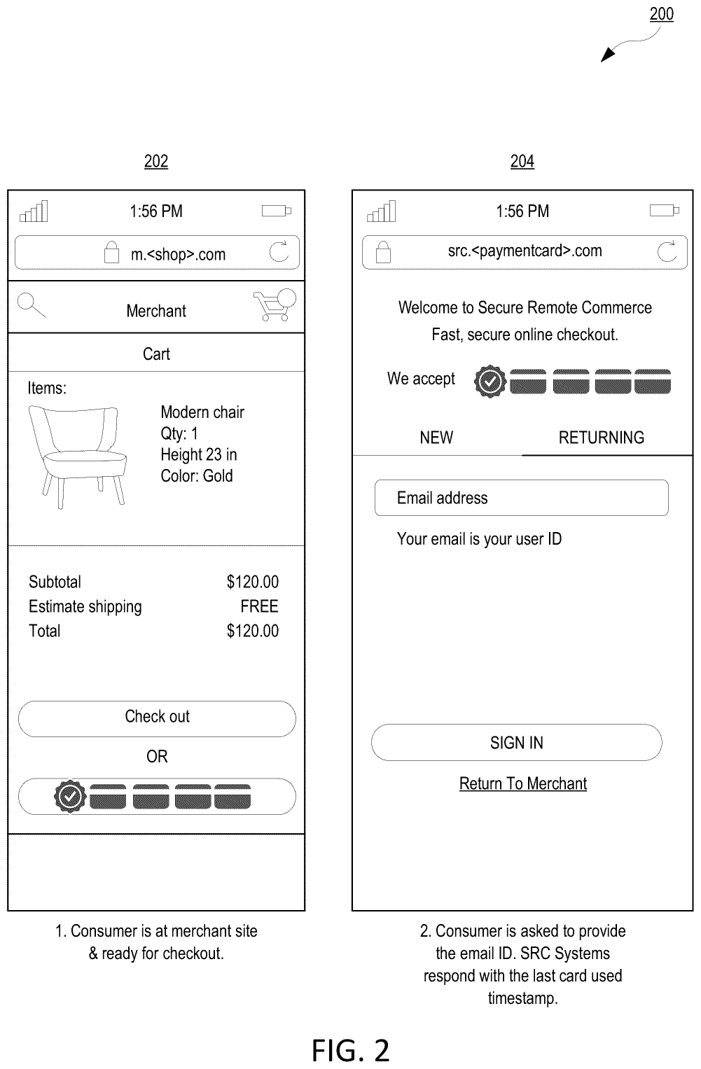

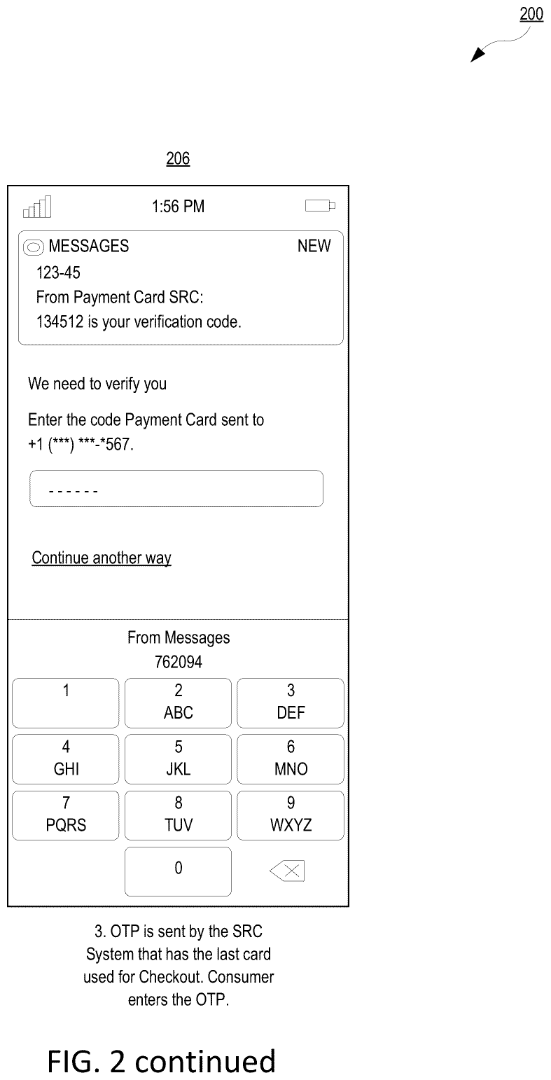

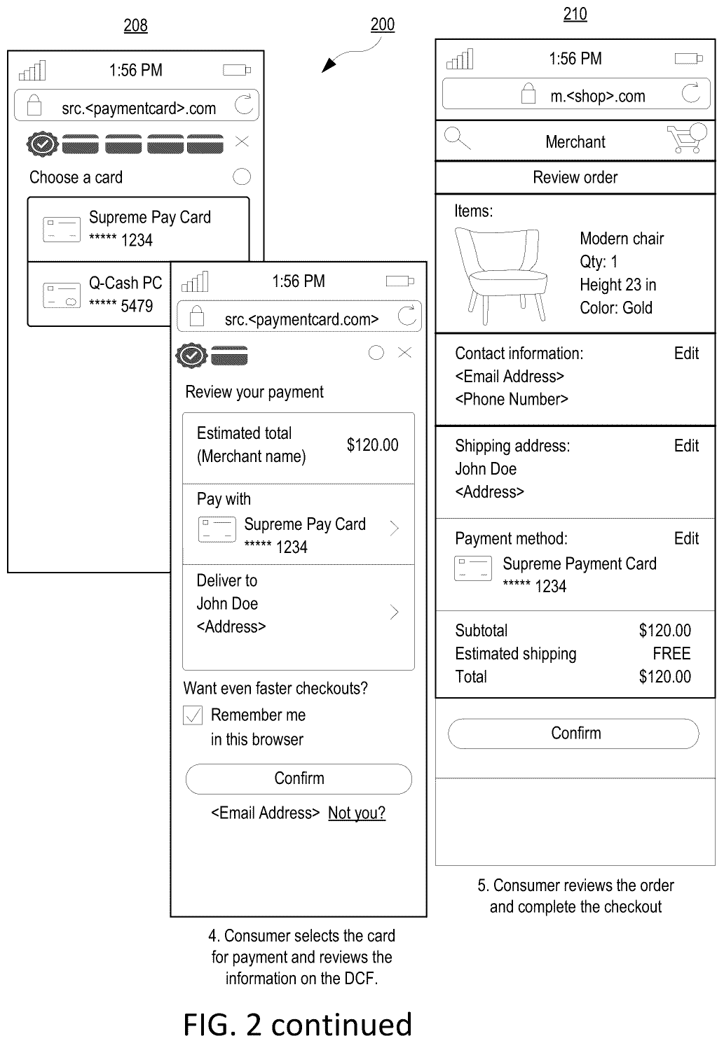

FIGS. 2-6 are flow diagrams illustrating non-exclusive exemplary user experiences or user interfaces for consumer identity validation for secure remote commerce (SRC) via a last used card (e.g., the last used card 166 of FIG. 1). In some examples, such exemplary user experiences or user interfaces are implemented at or within both physical financial transaction environments and online (e.g., e-commerce) financial transaction environments. In examples herein, such user interfaces or user experiences are presented to a user (a consumer, e.g., the user 160) by at least one of, for example: the GUI 150 of FIG. 1, the criteria selection GUI 128 of FIG. 1, an SRCi, a DSA, a Digital Payment Application (DPA), or a DCF. In such examples, in order to present such user interfaces or user experiences, each of these elements work either alone or in concert in various combinations. In some examples, the exemplary user interfaces or user experiences for consumer identity validation illustrated by FIGS. 2-6 are provided separately or in various combinations by a system (e.g., the system 100 of FIG. 1).

FIG. 2 is a flow diagram illustrating an example of a first pop-up experience 200 (the “experience 200”) for consumer identity validation for SRC via a last used card. In some examples, the experience 200 is presented to a consumer via at least one of a pop-up window, modal dialog box, or modeless dialog box.

At 202, the consumer is present at a merchant site and ready for checkout to complete a transaction. In some examples, the merchant site is, e.g., a website visited on a mobile device or any other computing device.

At 204, the consumer is prompted to provide identification (e.g., the user identifier 164 of FIG. 1). In some examples of a popup experience, the branding and other user interface/user experience elements associated with at least one SRC system are displayed to the consumer, such that the branding and other user interface/user experience elements associated with at least one SRC system temporarily take over the experience 200. Upon receiving the identification, all available SRC systems respond with the last used card timestamp associated with each available SRC system. A target SRC system, having responded with the most recent last used account timestamp, is chosen. In some examples, the target SRC system is chosen by an SRCi.

At 206, as at least part of a user identity authentication operation, the SRCi receives from the target SRC system a request for user authentication. In some examples, this request is in the form of an OTP transmitted by the target SRC system to the SRCi. The transmitted OTP is entered by the consumer into the SRCi (e.g., via the DCF) and transmitted back to the target SRC system. In some examples, this request is in other forms, as discussed elsewhere herein.

At 208, the consumer has been successfully authenticated. The consumer identity validation is complete, and the transaction proceeds. The consumer selects a payment card from the list of cards associated with the target SRC system presented to the consumer at least in part by the SRCi. After this selection, the consumer reviews information about the pending payment (e.g., via the DCF).

At 210, the consumer completes the review of the transaction, and inputs a confirmation to complete the checkout. This concludes the transaction interaction with the GUI by the consumer. The transaction is then processed using the selections made by the consumer.

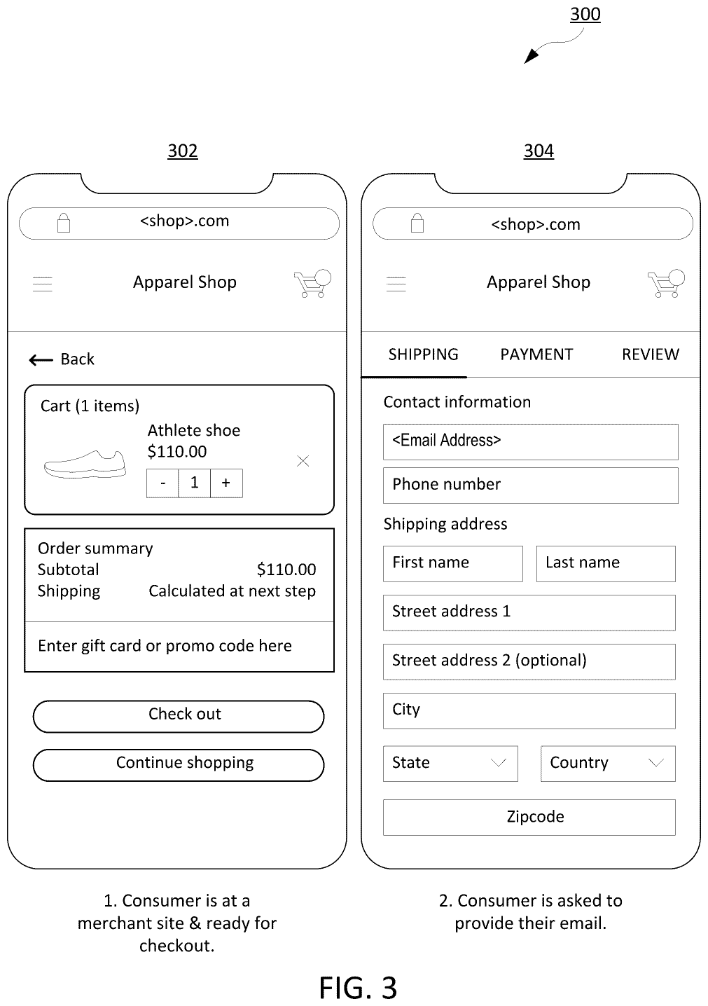

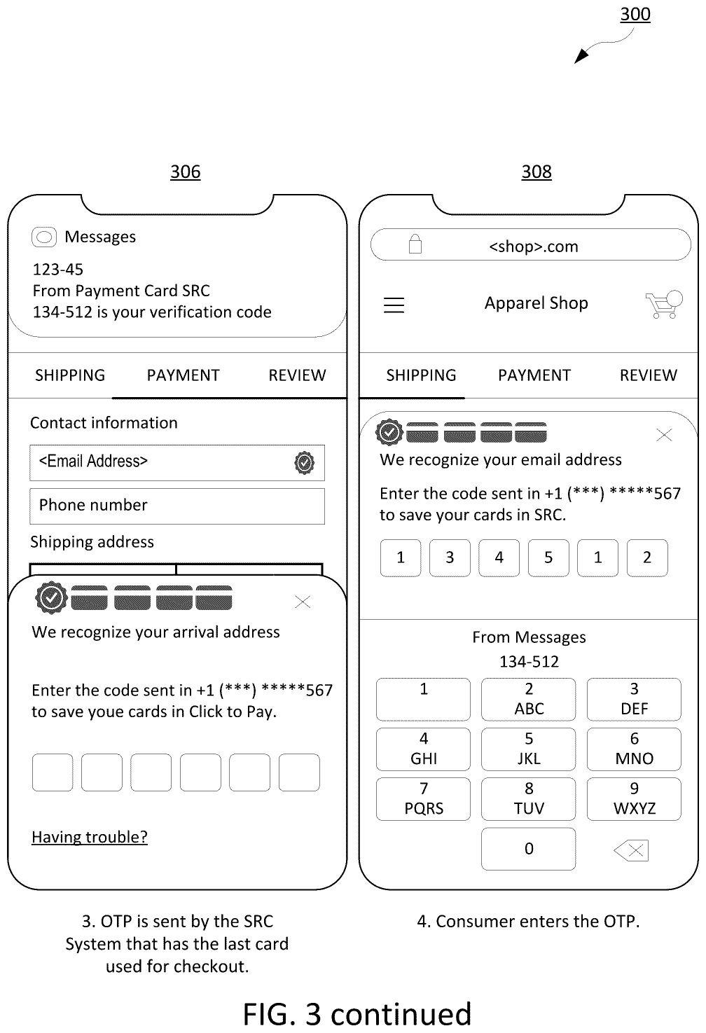

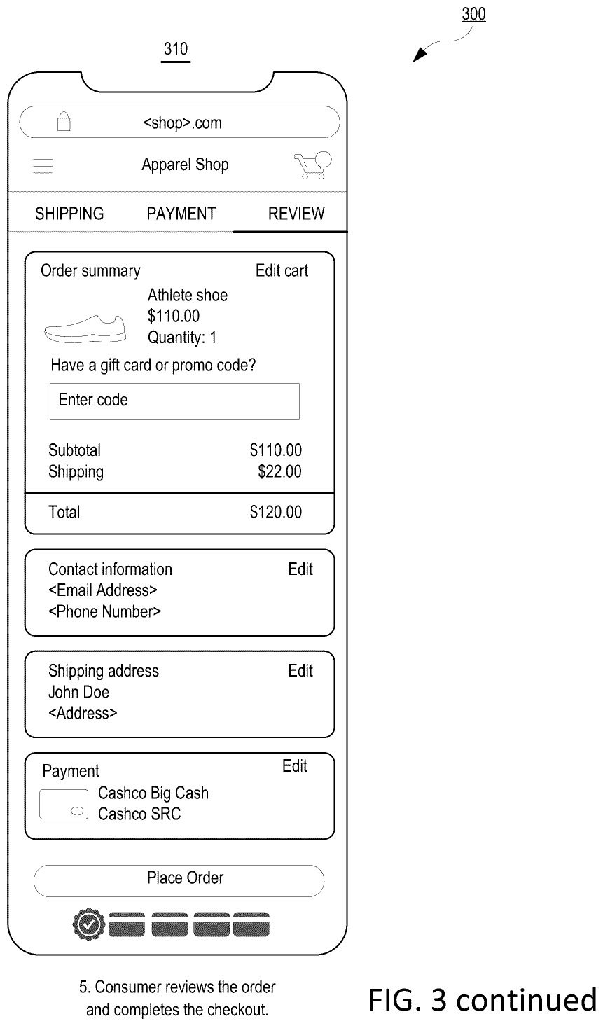

FIG. 3 is a flow diagram illustrating an example of a first embedded experience 300 (the “experience 300”) for consumer identity validation for SRC via a last used card (e.g., the last used card 166 of FIG. 1). In some examples, the experience 300 is presented to a consumer via at least one user interface element embedded into another user interface or user experience. In some such examples of the experience 300, and in contrast to the experience 200, no branding or other user interface/user experience elements associated with at least one SRC system are displayed to the consumer. The experience 300 thus remains primarily associated with the merchant participating in the transaction.

At 302, the consumer is present at a merchant site and ready for checkout to complete a transaction. In some examples, the merchant site is, e.g., a website visited on a mobile device or any other computing device.

At 304, the consumer is prompted to provide identification (e.g., the user identifier 164 of FIG. 1). Upon receiving the identification, all available SRC systems respond with the last used card timestamp associated with each available SRC system. A target SRC system, having responded with the most recent last used account timestamp, is chosen. In some examples, the target SRC system is chosen by an SRCi.

At 306, as at least part of a user identity authentication operation, the SRCi receives from the target SRC system a request for user authentication. In some examples, this request is in the form of an OTP transmitted by the target SRC system to the SRCi. In some examples, this request is in other forms, as discussed elsewhere herein.

At 308, the transmitted OTP is entered by the consumer into the SRCi (e.g., via the DCF) and transmitted back to the target SRC system.

At 310, the consumer has been successfully authenticated. The consumer identity validation is complete, and the transaction proceeds. The most recent last used card, being associated with the target SRC, is automatically selected for use to complete the transaction. After this selection, the consumer reviews information about the pending payment (e.g., via the DCF). The consumer completes the review of the transaction and inputs a confirmation to complete the checkout. This concludes the transaction interaction with the GUI by the consumer. The transaction is then processed using the selections made by the consumer.

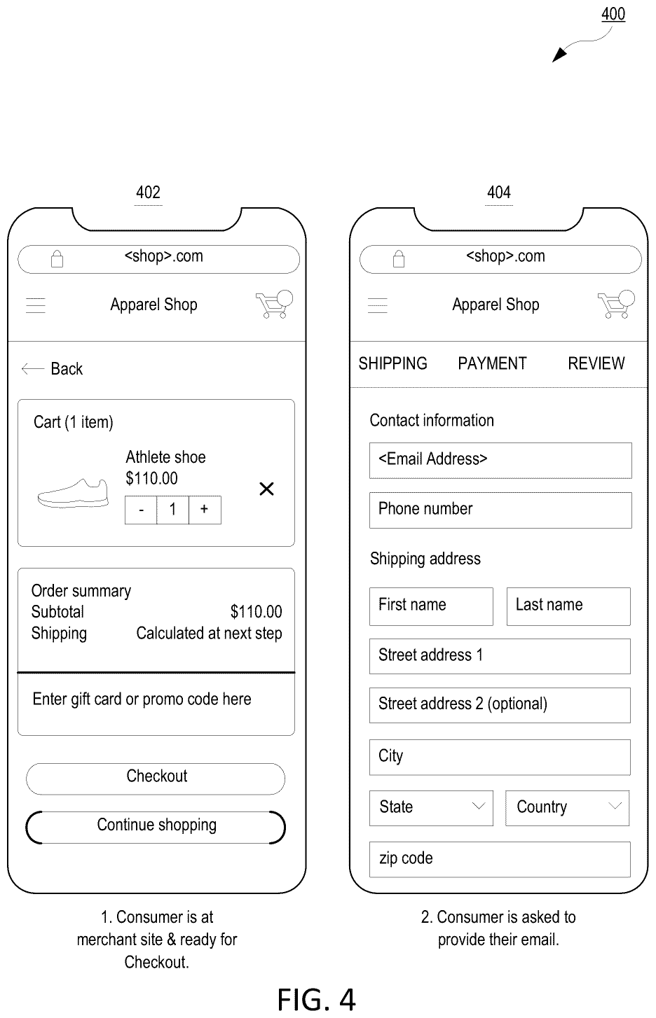

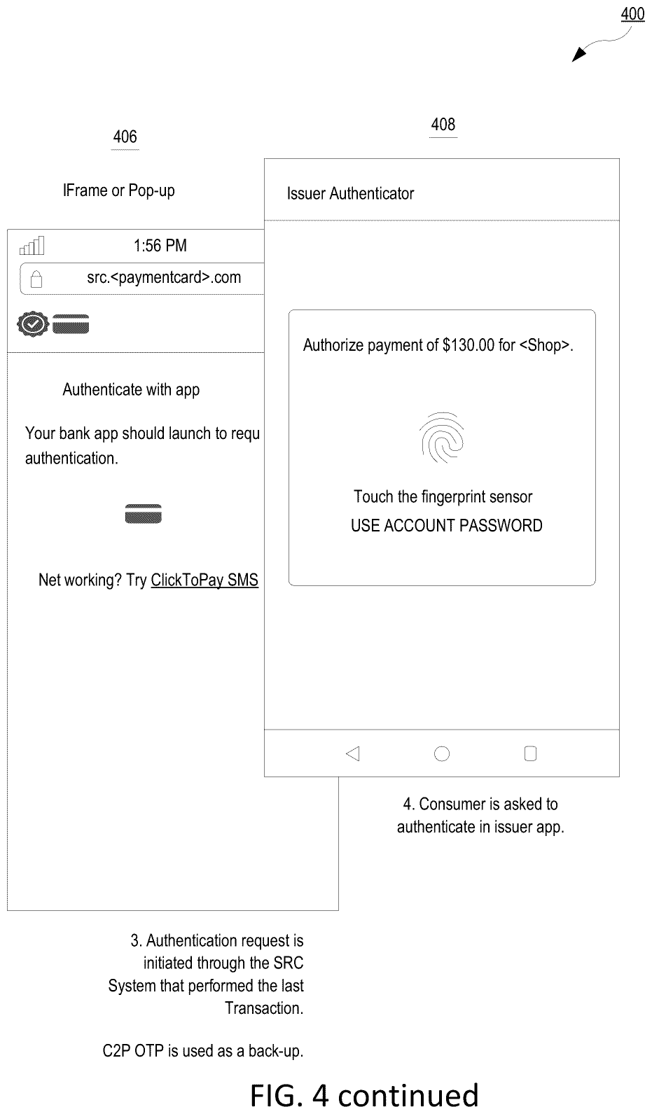

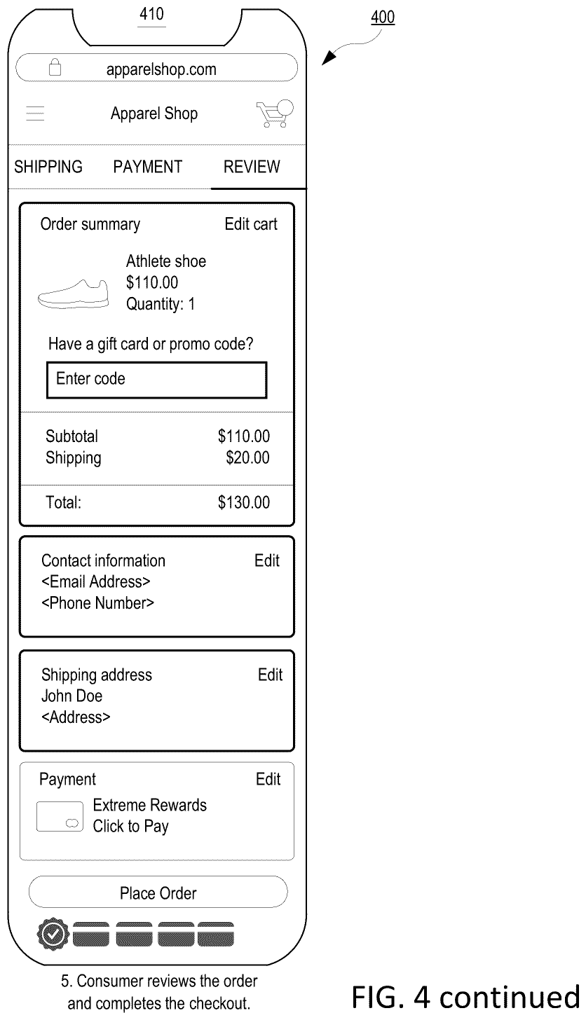

FIG. 4 is a flow diagram illustrating an example of a second embedded experience 400 (the “experience 400”) for consumer identity validation for SRC via a last used card (e.g., the last used card 166 of FIG. 1). The experience 400 is embedded as defined in the discussion of the experience 300, except that the authentication occurs in a separate application. Further, in some examples, the experience 400 utilizes a user interface or user experience hosted by a specific credit card network (e.g., MASTERCARD®).

At 402, the consumer is present at a merchant site and ready for checkout to complete a transaction. In some examples, the merchant site is, e.g., a website visited on a mobile device or any other computing device.

At 404, the consumer is prompted to provide identification (e.g., the user identifier 164 of FIG. 1).

At 406, upon receiving the identification, the SRC system that performed the last transaction associated with the consumer is identified. This identified SRC system is chosen as the target SRC system to facilitate the current transaction with this consumer. In some examples, the target SRC system is chosen by an SRCi. The authentication request is initiated through the target SRC system.

In some examples, the SRC system that performed the last transaction associated with the consumer cannot be identified or is otherwise unavailable, for whatever reason. In such examples, a back-up authentication method is presented to the consumer. In some such examples, this is, e.g., the experience 200. The experience 200 replaces operations 408 and 410 described below.

At 408, the consumer is asked to authenticate via an application (or “app”). The consumer will temporarily be transferred from the merchant site to the application. In some examples, this application is a DPA or DSA. In some examples, this application is provided by the specific credit card network (e.g., MASTERCARD®) hosting the user interface or user experience. Authentication proceeds in at least one of the forms discussed elsewhere herein (e.g., biometric via thumbprint or facial recognition, etc.).

At 410, the consumer has been successfully authenticated and automatically returned to the merchant site to continue the transaction. The consumer identity validation is complete, and the transaction proceeds. The most recent last used card, being associated with the target SRC, is automatically selected for use to complete the transaction. After this selection, the consumer reviews information about the pending payment (e.g., via the DCF). The consumer completes the review of the transaction and inputs a confirmation to complete the checkout. This concludes the transaction interaction with the GUI by the consumer. The transaction is then processed using the selections made by the consumer.

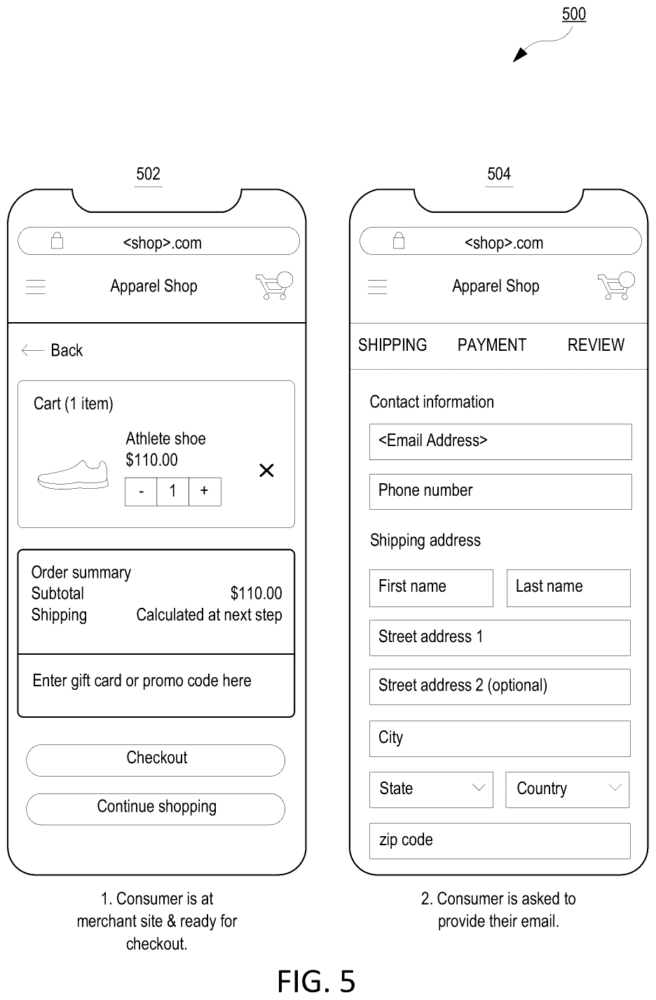

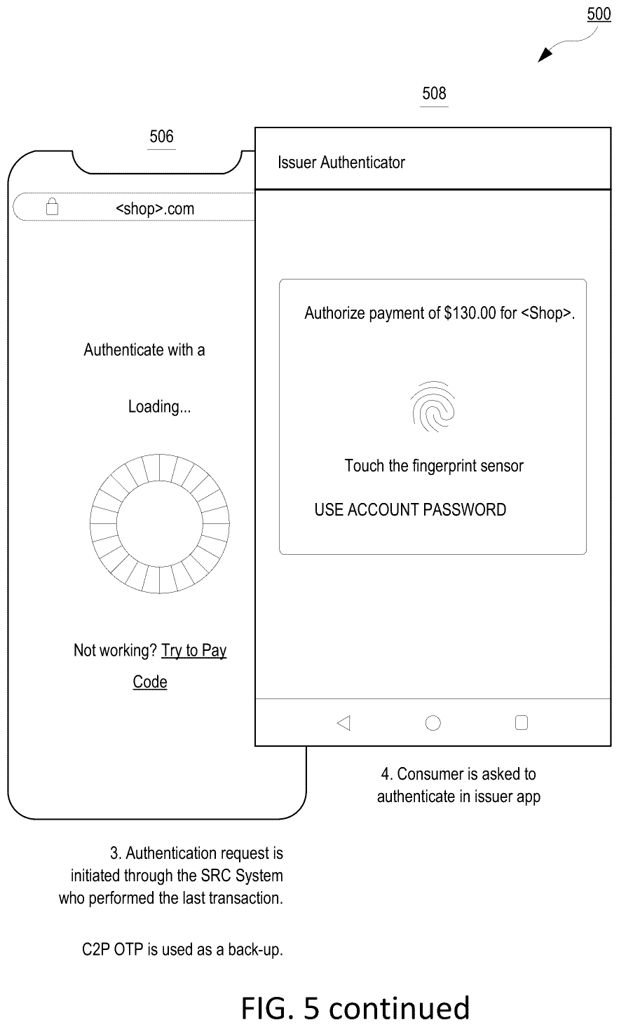

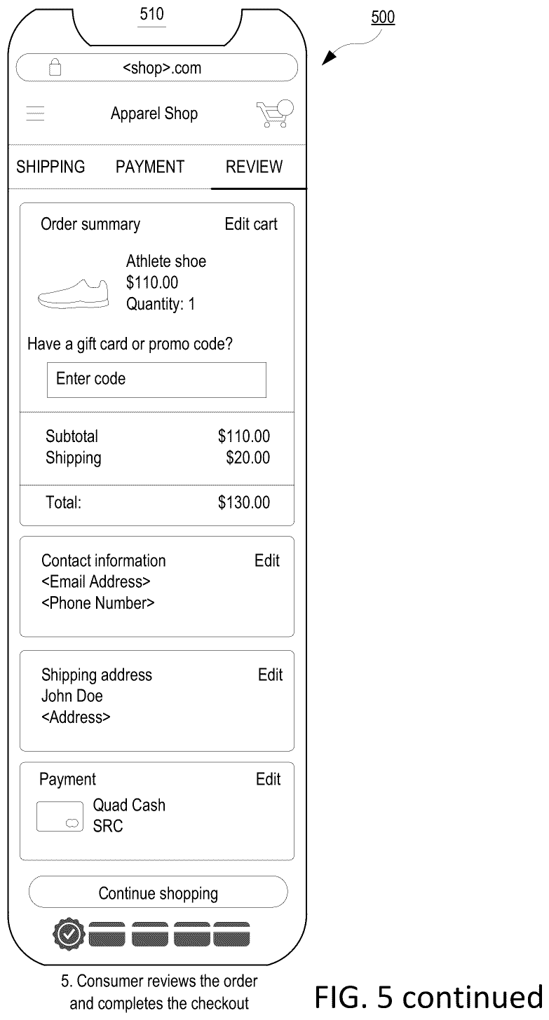

FIG. 5 is a flow diagram illustrating an example of a DPA/SRCi-hosted user interface experience 500 (“the experience 500”) for consumer identity validation for SRC via a last used card (e.g., the last used card 166 of FIG. 1). In some examples, the experience 500 utilizes a user interface or user experience hosted by a specific DPA/DSA or SRCi. In some such examples, any one of the DPA/DSA or SRCi is possibly, but is not required to be, affiliated with the chosen target SRC (see below).

At 502, the consumer is present at a merchant site and ready for checkout to complete a transaction. In some examples, the merchant site is, e.g., a website visited on a mobile device or any other computing device.

At 504, the consumer is prompted to provide identification (e.g., the user identifier 164 of FIG. 1).

At 506, upon receiving the identification, the SRC system that performed the last transaction associated with the consumer is identified. This identified SRC system is chosen as the target SRC system to facilitate the current transaction with this consumer. In some examples, the target SRC system is chosen by an SRCi. The authentication request is initiated through the target SRC system.

In some examples, the SRC system that performed the last transaction associated with the consumer cannot be identified or is otherwise unavailable, for whatever reason. In such examples, a back-up authentication method is presented to the consumer. In some such examples, this is, e.g., the experience 200. The experience 200 replaces operations 508 and 510 described below.

At 508, the consumer is asked to authenticate via an application. The consumer will temporarily be transferred from the merchant site to the application. In some examples, this application is a DPA or DSA. In some examples, this application is provided by the specific credit card network (e.g., MASTERCARD®) hosting the user interface or user experience. Authentication proceeds in at least one of the forms discussed elsewhere herein (e.g., biometric via thumbprint or facial recognition, etc.).

At 510, the consumer has been successfully authenticated and automatically returned to the merchant site to continue the transaction. The consumer identity validation is complete, and the transaction proceeds. The most recent last used card, being associated with the target SRC, is automatically selected for use to complete the transaction. After this selection, the consumer reviews information about the pending payment (e.g., via the DCF). The consumer completes the review of the transaction and inputs a confirmation to complete the checkout. This concludes the transaction interaction with the GUI by the consumer. The transaction is then processed using the selections made by the consumer.

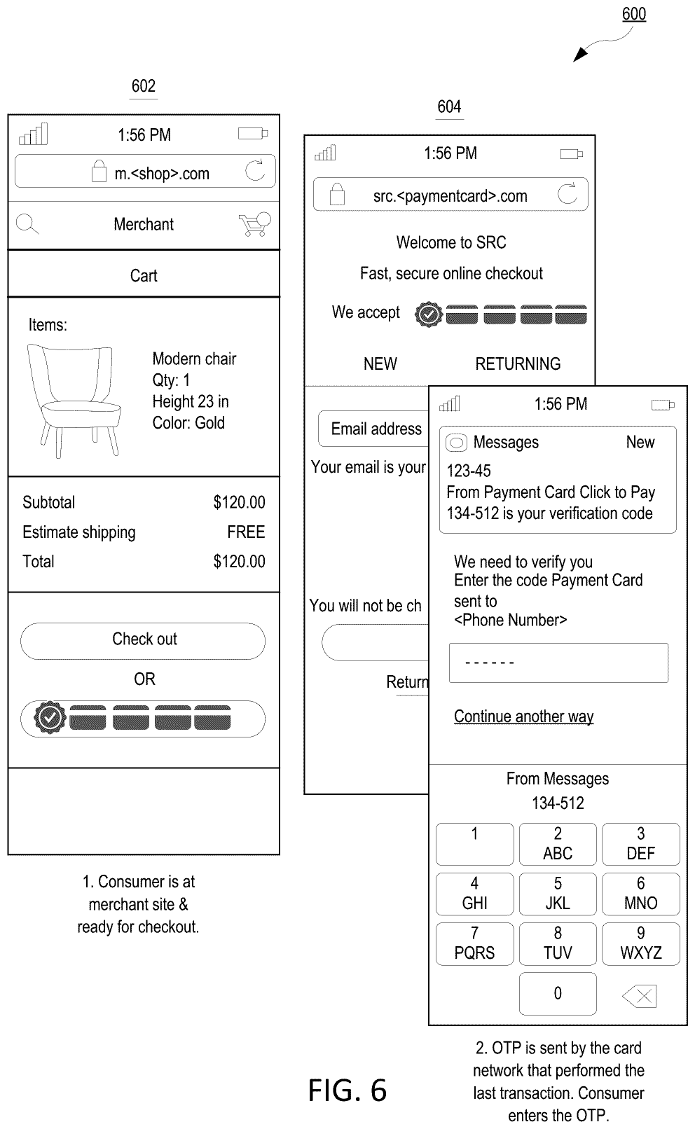

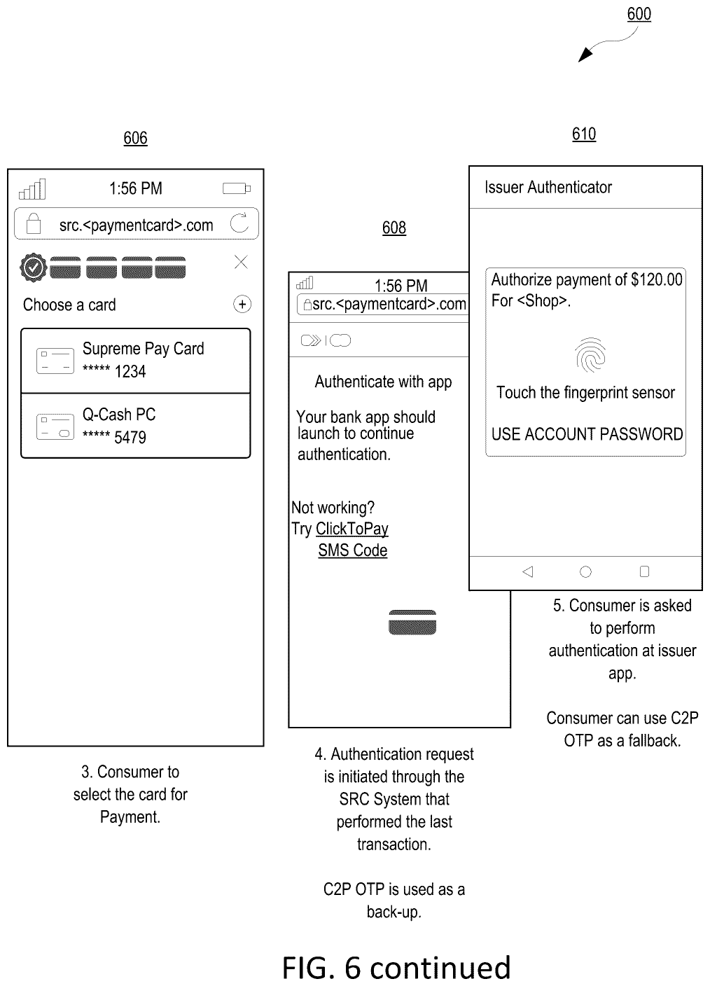

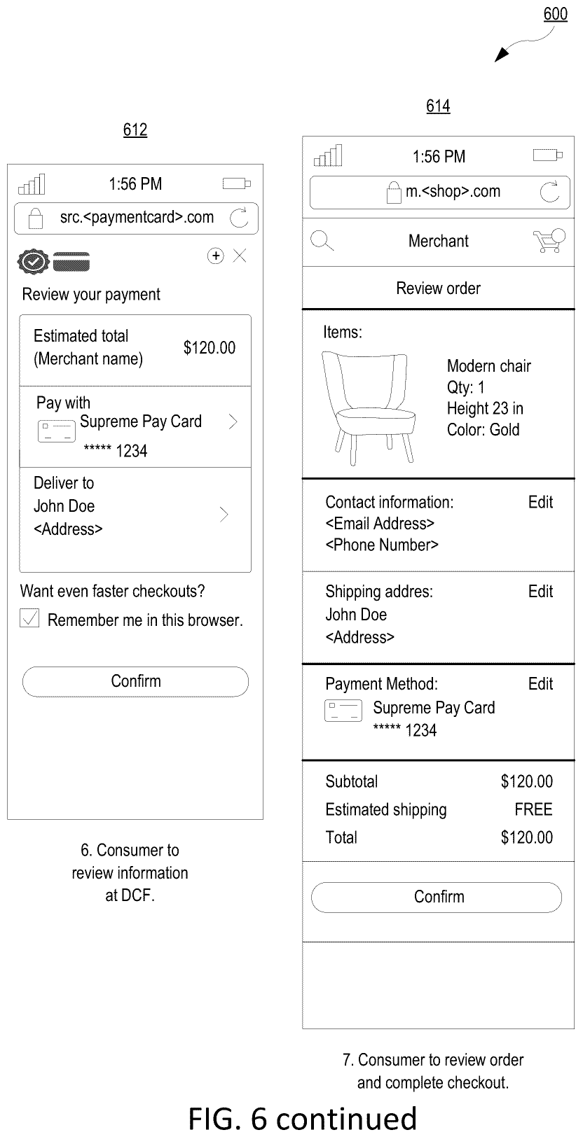

FIG. 6 is a flow diagram illustrating an example of a third embedded experience 600 (the “experience 600”) for a recognized user for consumer identity validation for SRC via a last used card (e.g., the last used card 166 of FIG. 1). In some examples of the experience 600, the consumer is recognized (e.g., on the DSA or DPA). In some such examples, recognition is facilitated via at least one of the SRCi or SRC leaving an identifying token on or in the DSA or DPA. This token is in some examples a cookie. A cookie comprises data sent by at least one of the SRC system or SRCi to the DSA or DPA. The DSA or DPA returns the cookie to the SRC system or SRCi each time the DSA or DPA subsequently contacts the SRC provider or SRCi. The cookie identifies DSA or DPA as being associated with a specific consumer, and thus automatically identifies the consumer to the SRCi and SRC provider. The consumer need not provide any identification (e.g., the user identifier 164 of FIG. 1).

At 602, the consumer is present at a merchant site and ready for checkout to complete a transaction. In some examples, the merchant site is, e.g., a website visited on a mobile device or any other computing device.

At 604, the SRC system that performed the last transaction associated with the consumer is identified. In some examples, this SRC system is associated with a specific payment card network. This identified SRC system is chosen as the target SRC system to facilitate the current transaction with this consumer. In some examples, the target SRC system is chosen by an SRCi.

The consumer is asked to authenticate in a first authentication operation with the payment card network that performed the last transaction associated with at least one of this consumer or this consumer in combination with this merchant site. The first authentication operation occurs either at the merchant site or via an application. Either of these authentication methods are described in further detail herein in the discussions of the experiences 200, 300, 400, and 500. The consumer completes authentication.

At 606, the consumer has been successfully authenticated with the payment card network. The consumer selects a payment card from the list of cards associated with the target SRC system presented to the consumer at least in part by the SRCi. In some examples, the target SRC is associated with the payment card network that performed the last transaction described above.

At 608, as at least part of a user identity authentication operation, the SRCi receives from the target SRC system a request for user authentication. The authentication request is initiated through the target SRC system that performed the last transaction. In some examples, this request is in the form of an OTP transmitted by the target SRC system to the SRCi. In some examples, this request is in other forms, as discussed elsewhere herein.

In some examples, the SRC system that performed the last transaction associated with the consumer cannot be identified or is otherwise unavailable, for whatever reason. In such examples, a back-up authentication method is presented to the consumer. In some such examples, this is, e.g., the experience 200. The experience 200 replaces operations 610, 612 and 614 described below. Authentication proceeds in at least one of the forms discussed elsewhere herein (e.g., biometric via thumbprint or facial recognition, etc.).

At 610, the consumer is asked to authenticate via an application. The consumer will temporarily be transferred from the merchant site to the application. In some examples, this application is a DPA or DSA. In some examples, authentication via application fails due to technical difficulties. In such examples, a back-up authentication method is presented to the consumer. In some such examples, this is, e.g., the experience 200. The experience 200 replaces operations 612 and 614 described below.

At 612, the consumer has been successfully authenticated and automatically returned to the merchant site to continue the transaction. The consumer identity validation is complete, and the transaction proceeds. The most recent last used card, being associated with the target SRC, is automatically selected for use to complete the transaction. After this selection, the consumer reviews information about the pending payment (e.g., via the DCF).

At 614, the consumer completes the review of the transaction, and inputs a confirmation to complete the checkout. This concludes the transaction interaction with the GUI by the consumer. The transaction is then processed using the selections made by the consumer.

In some examples, the experience 600 enables leveraging an application provided by at least one of a payment card network or digital wallet provider (e.g., a DSA or DSA, etc.) associated with a consumer to provide consumer identity validation of the consumer before operation 602. In some such examples, a consumer chooses to conduct consumer identity validation before beginning the checkout process for a transaction with a merchant. In such cases, an SRCi conducts the consumer identity validation using the target SRC and a preferred card associated with the target SRC, as described above in the description of the experience 600.

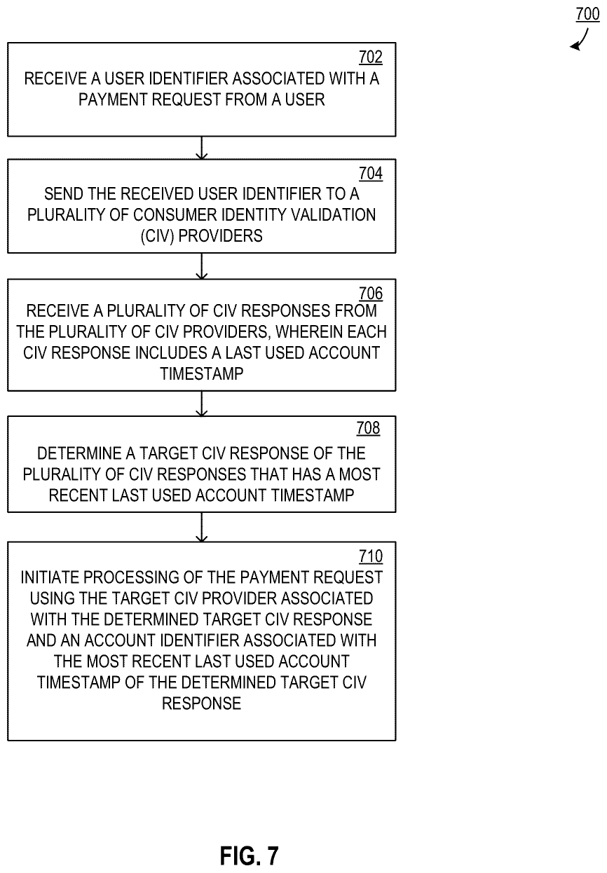

FIG. 7 is a flow chart illustrating a computerized method 700 for consumer identity validation via a last used card (e.g., the last used card 166 of FIG. 1). In some examples, the computerized method uses a processor (e.g., the processor 102 of FIG. 1). In some examples, the method 700 is executed or otherwise performed in a system such as the system 100 of FIG. 1.

At 702, the processor receives a user identifier associated with a payment request from a user.

At 704, the processor sends the received user identifier to a plurality of Consumer Identity Validation (CIV) providers. In some examples, the plurality of CIV providers includes at least one SRC provider as described herein.

At 706, the processor receives a plurality of CIV responses from the plurality of CIV providers, wherein each CIV response includes a last used account timestamp.

At 708, the processor determines a target CIV response of the plurality of CIV responses that has a most recent last used account timestamp.

At 710, the processor initiates processing of the payment request. The initiation uses the target CIV provider associated with the determined target CIV response and an account identifier associated with the most recent last used account timestamp of the determined target CIV response.

In some examples, initiating processing of the payment request includes performing a user identity authentication operation. In some such examples, the user identity authentication operation includes at least one of the following:
user authentication using a password,
user authentication using a one-time password (OTP),
user authentication using Two-factor authentication (2FA), and
user authentication using biometric authentication.

In other examples, initiating processing of the payment request further includes the processor displaying information associated with the target CIV provider of the determined target CIV response. The processor displays the information using a GUI. The processor further prompts the user to confirm use of an account identified by the account identifier associated with the most recent last used account timestamp using the GUI. Additionally, the processor receives confirmation to use the account from the user using the GUI. Further, the processor completes processing of the payment request using the account confirmed by the user.

Some examples of the computerized method 700 further comprise the processor filtering the received plurality of CIV responses using a filter criteria set. The filter criteria set includes at least one filter criterion. In some such examples, determination of the target CIV response of the plurality of CIV responses by the processor includes determining the CIV response of a filtered plurality of CIV responses that has the most recent last used account timestamp.

In other such examples, the filter criteria set includes at least one of the following:
a first filter criterion based on transaction types associated with the last used account timestamps,
a second filter criterion based on merchants associated with the last used account timestamps,
a third filter criterion based on location data associated with the last used account timestamps, and
a fourth filter criterion based on available account perks of accounts associated with the last used account timestamps.

In yet other such examples, the processor prompts the user to select the filter criteria set from a set of possible filter criteria using a criteria selection GUI. The processor further receives a set of selected criteria from the criteria selection GUI, the set of selected criteria including at least one selected criterion. Additionally, the processor defines the filter criteria set using the received set of selected criteria.

### Secure Remote Commerce

Modern financial transaction environments, including online transaction environments, present several new and challenging difficulties and dangers. In particular, such environments are not currently standardized, or only partially standardized, such that there is a large amount of variation in implementation. This leads to complexity and inconsistency. Further, remote payments are being increasingly targeted by bad actors, and are susceptible to compromise. In addition, users are often required to enter payment data and related checkout data in many places, leading to further risk of data compromise and fraud.

Partly responsive to these difficulties and dangers, the still-evolving Secure Remote Commerce (SRC) standard has emerged. SRC, also referred to as EMV® Secure Remote Commerce (EMV® SRC), is maintained by EMVCO®, on behalf of EMVCO®'s constituent members. SRC seeks to harmonize online transaction environments. SRC is a payment platform, including a technical framework and specifications that enable the secure exchange of data for payment transactions. SRC connects customers, merchants, issuers, acquirers, and other entities and enables a merchant to obtain a payload of customer payment information that can be used for payment transaction authorization.

In some such examples, at least one SRC system is operated by or on behalf of different entities to facilitate transactions. Each such SRC system is operated by, for example, a payment network (such as Mastercard International Incorporated or other network providers). In some such examples, other entities operate SRC systems. Each such SRC system coordinates messages and transactions among transaction participants (including, as non-limiting examples, a mobile device of a consumer, a Digital Shopping Application (DSA), and a transaction initiation system).

In this context, each payment network keeps track of the identity of a consumer network member and the payment cards associated with the payment network that belong to that consumer network member. Thus, at each payment network, each consumer network member has a single account (sometimes referred to interchangeably as an “SRC account” or “SRC profile”) with the SRC provider associated with the payment network. For each consumer, that account is associated with at least one payment card issued by the payment network.

In some examples, each SRC system trusts the other SRC systems as identity providers usable to validate a consumer's identity as described herein.

In some examples, the DSA, also sometimes called a digital payment application (DPA), facilitates the consumer experience during an SRC transaction. Examples of DSAs include but are not limited to a web application or mobile application (e.g., an application available to download onto a smartphone or computing device) configured to allow a consumer to purchase goods or services from a merchant; marketplace or other service provider. Example SRC systems provide at least one DSA. In some such examples, each such DSA is operatable by, or on behalf of, a merchant, a marketplace, or a service provider that maintains, administers, and manages, e.g., hosted order pages on behalf of merchants or marketplaces. The DSA is not limited to shopping applications; in some examples the DSA also facilitates other types of payment transactions.

In some such examples, the transaction initiation system comprises at least one of a Secure Remote Commerce Initiator (SRCI or SRCi, herein), and a Digital Card Facilitator (DCF). The transaction initiation system, by initiating the transaction, facilitates remote card payments pursuant to the present disclosure.

In some examples, the SRCi facilitates the collection and transmission of at least one of digital card and checkout information on behalf of a DSA to enable the initialization of a payment transaction. In some such examples, the SRCi securely exchanges data with an SRC system. This includes but is not limited to providing checkout data to the SRC system. The SRCi also securely receives payload information from the SRC system for use in completing a payment transaction using that payload. In some such examples, more than one SRCi is available to a consumer engaged in a transaction, and each SRCi is operable, for example, by or on behalf of a merchant system (e.g., such as by a merchant service provider or the like).

In some examples, the DCF includes any component(s) that provide a user experience for consumers during a transaction. More particularly, the DCF provides consumers with a user interface (or portions of a user interface) that is usable during a checkout process, card management (e.g., when card data is stored in the consumer's profile or an SRC profile at an SRC system), or for other card-related tasks.

In some examples, the DCF provides user interfaces (or portions of user interfaces) to facilitate, e.g., billing address entry, shipping address entry and selection, consumer profile creation, binding of payment cards and addresses to SRC profiles, as well as user interfaces to facilitate consumer/payment assurance challenges (e.g., for use with authentication processes). In some examples, the transaction initiation system includes more than one DCF. In some such examples, each of the more than one DCFs are operated by or on behalf of different entities, including but not limited to: an SRC system operator, a card issuer, a merchant, a browser provider.

### Enhanced Consumer Purchase Experience

The ease-of-use and reliability of the consumer purchase experience when buying goods or services, either via in-person or online/e-commerce transaction environments, has continued to grow in importance as consumers are confronted with an increasingly complex array of options for completing financial transactions via a payment card. Key to completing such transactions is CIV. Unfortunately, traditional mechanisms for CIV provide a disjointed, inefficient experience.

This infuses the transaction with additional and unnecessary friction, inconvenience, and inefficiency. In the long term, consumers do not tolerate unnecessary friction, inconvenience, annoyance, and inefficiency. Thus, traditional CIV risks causing financial damage to the merchant not only through potential loss of the repeat business of existing customers, but also through reputational damage that risks the loss of potential new business. For example, a merchant relying on traditional mechanisms for CIV risks becoming known for a slow, inefficient, and cumbersome purchase transaction completion process and enduring financial consequences, while their competitors, unburdened by such a reputation, flourish. Additionally, unnecessary friction, inconvenience, annoyance, and inefficiency associated with CIV depress the adoption of modern payment systems, denying both consumers and merchants the benefits of these modern payment systems.

The systems, methods, and computer readable media disclosed herein improve the ease-of-use and reliability of the consumer purchase experience when buying goods or services, either via in-person or online/e-commerce transaction environments. Examples herein provide unified, seamless, and efficient experiences and mechanisms (e.g., systems, methods, and computer readable media) for completing consumer identity validation during a transaction.

### ADDITIONAL EXAMPLES

In some examples, a “card,” in the context of a “last used card,” is at least one of:
A credit card;
A charge card;
A bank card;
An ATM (automatic teller machine) card;
A client card;
A key card;
A cash card;
A debit card;
A prepaid card;
A smart card;
A line of credit or instant loan accessible via a card with equivalent function to a credit card; and
Any other payment card or equivalent enabling a user (sometimes referred to as the “cardholder”) to pay a merchant for goods and services.

This non-exclusive list includes tangible (e.g., plastic) payment cards, and also intangible equivalents (e.g., those held in digital wallets, such as MASTERPASS® by MASTERCARD®) of any of the above. In addition, and without limiting any of the above, “card” also means at least one of:
A physical credit card that includes data that identifies an associated credit account;
A digital representation of a physical credit card that includes data that identifies an associated credit account; and/or
A set of data that identifies an associated credit account.

As used herein, in some examples an “account” is the credit account that is identified by data included in a card.

SRC systems and SRCi systems as discussed herein are implemented by various entities that provide financial services. Examples of such entities and the names of their implementations of SRC/SRCi systems include but are not limited to:
EMV®: Secure Remote Commerce;
MASTERCARD®: Click to Pay;
VISA®: Pay with Visa;
AMERICAN EXPRESS®: Click to Pay; and
DISCOVER®: Discover Secure Remote Commerce.

Some examples of the user identifier disclosed herein include at least one of the following:
User's email address;
User's phone number;
User's name;
User's nickname;
User's biometric data; and
Any other information associated with a specific user that is usable to identify that user, the identification being accurate enough for commercially practicable use.

As disclosed herein, a user identity authentication operation (e.g., the user identity authentication operation 110 of FIG. 1) is enabled via any mechanism capable of authenticating the identity of a user within the contexts of the examples disclosed herein. These include but are not limited to:
A password, including but not limited to: a string of characters that allows access to a system or service;
A one-time password (OTP), also referred to as a one-time PIN, one-time authorization code (OTAC) or dynamic password, including but not limited to: a password on a computer system or other digital device that remains valid for only a single login session or transaction and expires immediately thereafter;
Two-factor authentication (also referred to as multi-factor authentication) includes but is not limited to: an electronic authentication method wherein each user is granted access to a system, website, or application only after successfully presenting at least two pieces of evidence (or factors) to an authentication mechanism, which in some examples include at least two of knowledge only the user possesses, possession (something only the user possesses), and inherence (something only the user is); and
Biometric authentication includes but is not limited to: the automated or at least partially automated recognition of a user by analysis of physical characteristics unique to the user (e.g., retinal scans, finger prints, dental records, etc.).

Unless otherwise indicated, an “SRC system” and an “SRC provider” are used interchangeably herein.

In some examples, an SRCi is provided by and runs on a payment service provider (PSP). In such examples, a PSP is a third-party entity (e.g., not associated with a consumer or a merchant, but providing services to both) that assists merchants to accept payment for transactions with consumers. Such payments comprise multiple types of online payment methods, including but not limited to online banking, cards as defined herein, digital wallets, and the like. PSPs ensure a transaction between a consumer and a merchant complete with additional safely and security features provided by the PSP. In some examples, a PSP is referred to as “payment gateway” within the payment card industry.

In other examples, as discussed herein, an SRCi is provided directly by a credit card network (e.g., the MASTERCARD® credit card network).

In yet other examples, an SRC response (e.g., at least one SRC response 182 of the plurality of SRC responses 180 in FIG. 1) includes an indicator of which types of validation methods (e.g., pop-up experiences, embedded experiences, DSAs, DPAs, other applications, etc. as described herein) are supported by the SRC provider sending the SRC response.

In some examples, in order for an SRC response received from an SRC provider to be considered when determining a target SRC response, the SRC response must be received within a set length of time. An SRC response received after this set length of time has expired is not considered, even if the SRC response possesses the most recent last used timestamp. Some examples incorporating this feature refer to such a feature as a time out, timing out, or similar phrases. Some such examples incorporate this feature to, e.g., increase transaction efficiency.

Although specific examples are described herein with reference to SRC transactions, examples herein have broader applicability. Some examples are readily adaptable for use with other types of digital payment processes.

Some examples of this disclosure are adaptable for use with CIV transactions using alternatives to SRC, or mechanisms that augment SRC to provide additional features. Such alternatives or augmenting mechanisms include, but are not limited to, the following:
Specifications and standards codified, promulgated, and promoted by the Worldwide Web Consortium (W3C) Web Payments Working Group (see, e.g., https://www.w3.org/Payments/ and https://www.w3.org/Payments/WG/);
3-D SECURE® 2.0;
APPLE PAY® (alternatively known as APPLEPAY®);
ALIPAY®;
PAYPAL®; and
AMAZON® Pay.

In some examples, prior to receiving a user identifier associated with a payment request from a user, the payment request is received from the user. In response to receiving the payment request, a customer identifier is requested from the user.

In some examples of the systems, methods, and computer storage media disclosed herein, filter criteria are presented to the user. Using these filter criteria, the user optionally filters the list of cards in the SRC response returned by the SRC to the SRCi. This filtering allows the user to select a card even if that card is not the most recently used. Some examples of the filter criterion of these filter criteria disclosed herein include but are not limited to:
Transaction types associated with the last used account timestamps (e.g., the last used card associated with a specific type of transaction);
Merchants associated with the last used account timestamps (e.g., the last used card at a specific merchant);
Location data associated with the last used account timestamps; and
Available account perks of accounts associated with the last used account timestamps (e.g., the card with the best cashback or rewards for a specific purchase type).

Some examples use at least one of uniform resource locators (URLs) or a uniform resource identifier (URI) to enable communication between various components or elements. Non-limiting examples include: using a URL or URI to perform at least one of (1) initiating processing of a payment request; (2) initiating at least a user identity authentication operation by opening an application (e.g., a DSA or DPA) or web page; and (3) deep linking a consumer to an application (e.g., a DSA or DPA) that has been configured as an authenticator associated with the last used card. In some such examples, the deep link is able to launch the authenticator application if needed. In some other such examples, the link launches automatically without user interaction.

Some examples using a URL or URI utilize a web browser window to perform at least one of items (1), (2), and (3) in the preceding paragraph. In some such examples, the web browser window performs at least some of the functions performed by non-web browser applications (e.g., DSAs, DPAs, etc.) in other examples. In other examples, the web browser window uses the browsing context (e.g., the web browser window, an HTML iFrame, an HTML DIV element, etc.) to enable a target SRC system to facilitate a consumer identity validation user experience (e.g., at least one of the experience 200, 300, 400, 500, and 600) on behalf of a DPA/DSA or SRCi.

In other examples, a push notification is used either in place of or in combination with a URL or URI. Whether one or the other or both of a push notification or URL or URI is utilized in an example is dependent on the operating environment. In some examples using an APPLE® mobile device, at least one URI or URL, or a visible push notification, is used. Where the visible push notification is used, the user must manually interact with the visible push notification to be taken to the application. In some examples using an ANDROID® mobile device, an automatic, invisible push notification is used.

As discussed herein, some examples invoke applications (e.g., DSAs, DPAs, and other forms of card authentication applications) to conduct consumer identity validation. In some such examples, but not all, an SRCi invokes such an application only when the SRC profile associated with a consumer has a single card registered across all available SRC providers. If the SRC profile associated with a consumer has more than one card registered across all available SRC providers, an application is not used, and an experience that allows a consumer to select a card is chosen (e.g., the experience 200). In some of these examples, successful consumer identity validation by an application also triggers successful cardholder verification.

Some examples of the disclosed systems, methods, and computer readable media disclosed herein contain additional, optional features. These include, but are not limited to:
Substituting a payment request as disclosed herein with a record request, wherein access to the requested record is determined based at least in part on the verification of a user's identity as described herein.
In circumstances where no target SRC response can be determined, or no target SRC provider can otherwise be identified, fallback logic engages to allow a consumer to complete a transaction. In some examples, this fallback logic is random selection of one of the plurality of SRC providers that provided an SRC response.
In circumstances where only a single response is received from a single SRC provider, all target SRC response and target SRC provider selection logic is cancelled or skipped and the single responding SRC provider is chosen.

This list of optional features is not exclusive. Other examples of the disclosed systems, methods, and computer readable media disclosed herein contain additional, optional features not disclosed above.

### Exemplary Operating Environment

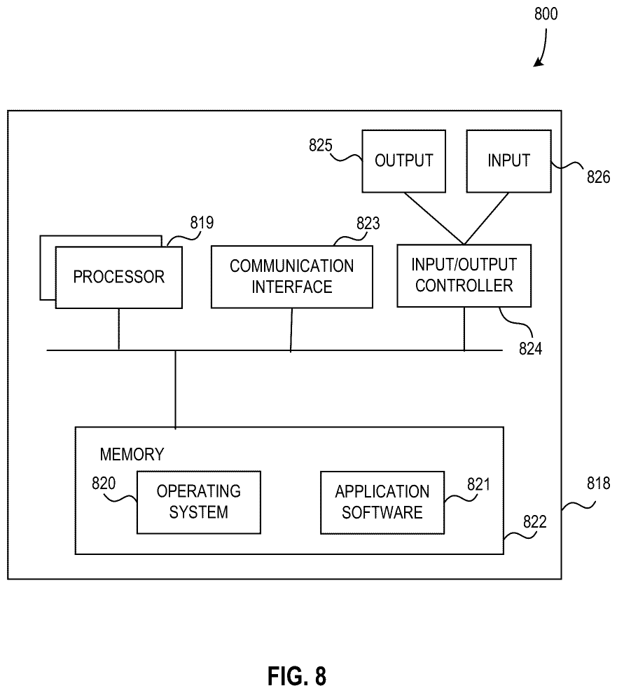

The present disclosure is operable with a computing apparatus according to an embodiment as a functional block diagram 800 in FIG. 8. In an example, components of a computing apparatus 818 are implemented as a part of an electronic device according to one or more embodiments described in this specification. The computing apparatus 818 comprises one or more processors 819 which may be microprocessors, controllers, or any other suitable type of processors for processing computer executable instructions to control the operation of the electronic device. Alternatively, or in addition, the processor 819 is any technology capable of executing logic or instructions, such as a hardcoded machine. In some examples, platform software comprising an operating system 820 or any other suitable platform software is provided on the apparatus 818 to enable application software 821 to be executed on the device. In some examples, validating a user identity for SRC based on a last used account as described herein is accomplished by software, hardware, and/or firmware.

In some examples, computer executable instructions are provided using any computer-readable media that are accessible by the computing apparatus 818. Computer-readable media include, for example, computer storage media such as a memory 822 and communications media. Computer storage media, such as a memory 822, include volatile and non-volatile, removable, and non-removable media implemented in any method or technology for storage of information such as computer readable instructions, data structures, program modules or the like. Computer storage media include, but are not limited to, Random Access Memory (RAM), Read-Only Memory (ROM), Erasable Programmable Read-Only Memory (EPROM), Electrically Erasable Programmable Read-Only Memory (EEPROM), persistent memory, phase change memory, flash memory or other memory technology, Compact Disk Read-Only Memory (CD-ROM), digital versatile disks (DVD) or other optical storage, magnetic cassettes, magnetic tape, magnetic disk storage, shingled disk storage or other magnetic storage devices, or any other non-transmission medium that can be used to store information for access by a computing apparatus. In contrast, communication media may embody computer readable instructions, data structures, program modules, or the like in a modulated data signal, such as a carrier wave, or other transport mechanism. As defined herein, computer storage media do not include communication media. Therefore, a computer storage medium should not be interpreted to be a propagating signal per se. Propagated signals per se are not examples of computer storage media. Although the computer storage medium (the memory 822) is shown within the computing apparatus 818, it will be appreciated by a person skilled in the art, that, in some examples, the storage is distributed or located remotely and accessed via a network or other communication link (e.g., using a communication interface 823).

Further, in some examples, the computing apparatus 818 comprises an input/output controller 824 configured to output information to one or more output devices 825, for example a display or a speaker, which are separate from or integral to the electronic device. Additionally, or alternatively, the input/output controller 824 is configured to receive and process an input from one or more input devices 826, for example, a keyboard, a microphone, or a touchpad. In one example, the output device 825 also acts as the input device. An example of such a device is a touch sensitive display. The input/output controller 824 may also output data to devices other than the output device, e.g., a locally connected printing device. In some examples, a user provides input to the input device(s) 826 and/or receive output from the output device(s) 825.

The functionality described herein can be performed, at least in part, by one or more hardware logic components. According to an embodiment, the computing apparatus 818 is configured by the program code when executed by the processor 819 to execute the embodiments of the operations and functionality described. Alternatively, or in addition, the functionality described herein can be performed, at least in part, by one or more hardware logic components. For example, and without limitation, illustrative types of hardware logic components that can be used include Field-Programmable Gate Arrays (FPGAs), Application-Specific Integrated Circuits (ASICs), Program-Specific Standard Products (ASSPs), System-on-a-Chip systems (SOCs), Complex Programmable Logic Devices (CPLDs), and Graphics Processing Units (GPUs).

At least a portion of the functionality of the various elements in the figures may be performed by other elements in the figures, or an entity (e.g., processor, web service, server, application program, computing device, etc.) not shown in the figures.

Although described in connection with an exemplary computing system environment, examples of the disclosure are capable of implementation with numerous other general purpose or special purpose computing system environments, configurations, or devices.

Examples of well-known computing systems, environments, and/or configurations that are suitable for use with aspects of the disclosure include, but are not limited to, mobile or portable computing devices (e.g., smartphones), personal computers, server computers, hand-held (e.g., tablet) or laptop devices, multiprocessor systems, gaming consoles or controllers, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. In general, the disclosure is operable with any device with processing capability such that it can execute instructions such as those described herein. Such systems or devices accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions, or the specific components or modules illustrated in the figures and described herein. Other examples of the disclosure include different computer-executable instructions or components having more or less functionality than illustrated and described herein.

In examples involving a general-purpose computer, aspects of the disclosure transform the general-purpose computer into a special-purpose computing device when configured to execute the instructions described herein.

An example system comprises: at least one processor; and at least one memory comprising computer program code, the memory and the computer program code configured to, with the processor, cause the processor to: receive a user identifier associated with a payment request from a user; send the received user identifier to a plurality of Consumer Identity Validation (CIV) providers; receive a plurality of CIV responses from the plurality of CIV providers, wherein each CIV response includes a last used account timestamp; determine a target CIV response of the plurality of CIV responses that has a most recent last used account timestamp; and initiate processing of the payment request using a target CIV provider associated with the determined target CIV response and an account identifier associated with the most recent last used account timestamp of the determined target CIV response.

An example computerized method comprises: receiving, by a processor, a user identifier associated with a payment request from a user; sending, by the processor, the received user identifier to a plurality of Consumer Identity Validation (CIV) providers; receiving, by the processor, a plurality of CIV responses from the plurality of CIV providers, wherein each CIV response includes a last used account timestamp; determining, by the processor, a target CIV response of the plurality of CIV responses that has a most recent last used account timestamp; and initiating, by the processor, processing of the payment request using a target CIV provider associated with the determined target CIV response and an account identifier associated with the most recent last used account timestamp of the determined target CIV response.

One or more example computer storage media have computer-executable instructions that, upon execution by a processor, cause the processor to at least: receive a user identifier associated with a payment request from a user; send the received user identifier to a plurality of Consumer Identity Validation (CIV) providers; receive a plurality of CIV responses from the plurality of CIV providers, wherein each CIV response includes a last used account timestamp; determine a target CIV response of the plurality of CIV responses that has a most recent last used account timestamp; and initiate processing of the payment request using a target CIV provider associated with the determined target CIV response and an account identifier associated with the most recent last used account timestamp of the determined target CIV response.

Alternatively, or in addition to the other examples described herein, examples include any combination of the following clause sets or clauses, which also describe further aspects.

Clause Set A:
A1. A system comprising:
   at least one processor; and
   at least one memory comprising computer program code, the at least one memory and the computer program code configured to, with the at least one processor, cause the at least one processor to:
      receive a user identifier associated with a payment request from a user;
      send the received user identifier to a plurality of Consumer Identity Validation (CIV) providers;
      receive a plurality of CIV responses from the plurality of CIV providers, wherein each CIV response includes a last used account timestamp;
      determine a target CIV response of the plurality of CIV responses that has a most recent last used account timestamp; and
      initiate processing of the payment request using a target CIV provider associated with the determined target CIV response and an account identifier associated with the most recent last used account timestamp of the determined target CIV response.
A2. The system of any preceding clause, wherein initiating processing of the payment request includes performing a user identity authentication operation.
A3. The system of any preceding clause, wherein the user identity authentication operation includes at least one of the following:
   user authentication using a password,
   user authentication using a one-time password (OTP),
   user authentication using two-factor authentication (2FA), and
   user authentication using biometric authentication.
A4. The system of any preceding clause, the at least one memory and the computer program code further configured to, with the at least one processor, cause the at least one processor to:
   filter the received plurality of CIV responses using a filter criteria set, wherein the filter criteria set includes at least one filter criterion; and
   wherein determining the target CIV response of the plurality of CIV responses includes determining the CIV response of a filtered plurality of CIV responses that has the most recent last used account timestamp.
A5. The system of any preceding clause, the at least one memory and the computer program code further configured to, with the at least one processor, cause the at least one processor to:
   prompt the user to select filter criteria set from a set of possible filter criteria using a criteria selection GUI;
   receive a set of selected criteria from the criteria selection GUI, the set of selected criteria including at least one selected criterion; and
   define the filter criteria set using the received set of selected criteria.
A6. The system of any preceding clause, wherein the filter criteria set includes at least one of the following:
   a first filter criterion based on transaction types associated with the last used account timestamps,
   a second filter criterion based on merchants associated with the last used account timestamps,
   a third filter criterion based on location data associated with the last used account timestamps, and
   a fourth filter criterion based on available account perks of accounts associated with the last used account timestamps.
A7. The system of any preceding clause, wherein initiating processing of the payment request further includes:
   displaying information associated with the target CIV provider of the determined target CIV response using a GUI;
   prompting the user via a user prompt to confirm use of an account identified by the account identifier associated with the most recent last used account timestamp using the GUI;
   receiving confirmation to use the account from the user using the GUI; and
   completing processing of the payment request using the account confirmed by the user.

Clause Set B:
B1. A computerized method comprising:
   receiving, by a processor, a user identifier associated with a payment request from a user;
   sending, by the processor, the received user identifier to a plurality of Consumer Identity Validation (CIV) providers;
   receiving, by the processor, a plurality of CIV responses from the plurality of CIV providers, wherein each CIV response includes a last used account timestamp;
   determining, by the processor, a target CIV response of the plurality of CIV responses that has a most recent last used account timestamp; and
   initiating, by the processor, processing of the payment request using a target CIV provider associated with the determined target CIV response and an account identifier associated with the most recent last used account timestamp of the determined target CIV response.
B2. The method of any preceding clause, wherein initiating processing of the payment request includes performing a user identity authentication operation.
B3. The method of any preceding clause, wherein the user identity authentication operation includes at least one of the following:
   user authentication using a password,
   user authentication using a one-time password (OTP),
   user authentication using Two-factor authentication (2FA), and
   user authentication using biometric authentication.
B4. The method of any preceding clause, further comprising:
   filtering, by the processor, the received plurality of CIV responses using a filter criteria set, wherein the filter criteria set includes at least one filter criterion; and
   wherein determining the target CIV response of the plurality of CIV responses includes determining the CIV response of a filtered plurality of CIV responses that has the most recent last used account timestamp.
B5. The method of any preceding clause, further comprising:
   prompting, by the processor, the user to select the filter criteria set from a set of possible filter criteria using a criteria selection GUI;
   receiving, by the processor, a set of selected criteria from the criteria selection GUI, the set of selected criteria including at least one selected criterion; and
   defining, by the processor, the filter criteria set using the received set of selected criteria.
B6. The method of any preceding clause, wherein the filter criteria set includes at least one of the following:
   a first filter criterion based on transaction types associated with the last used account timestamps,
   a second filter criterion based on merchants associated with the last used account timestamps,
   a third filter criterion based on location data associated with the last used account timestamps, and
   a fourth filter criterion based on available account perks of accounts associated with the last used account timestamps.
B7. The method of any preceding clause, wherein initiating processing of the payment request further includes:
   displaying, by the processor, information associated with the target CIV provider of the determined target CIV response using a GUI;
   prompting, by the processor, the user to confirm use of an account identified by the account identifier associated with the most recent last used account timestamp using the GUI;
   receiving, by the processor, confirmation to use the account from the user using the GUI; and
   completing, by the processor, processing of the payment request using the account confirmed by the user.

Clause Set C:
C1. One or more computer storage media having computer-executable instructions that, upon execution by a processor, cause the processor to at least:
   receive a user identifier associated with a payment request from a user; send the received user identifier to a plurality of Consumer Identity Validation (CIV) providers;
   receive a plurality of CIV responses from the plurality of CIV providers, wherein each CIV response includes a last used account timestamp;
   determine a target CIV response of the plurality of CIV responses that has a most recent last used account timestamp; and
   initiate processing of the payment request using a target CIV provider associated with the determined target CIV response and an account identifier associated with the most recent last used account timestamp of the determined target CIV response.
C2. The one or more computer storage media of any preceding clause, wherein initiating processing of the payment request includes performing a user identity authentication operation, the user identity authentication operation comprising at least one of the following:
   user authentication using a password,
   user authentication using a one-time password (OTP),
   user authentication using two-factor authentication (2FA), and
   user authentication using biometric authentication.
C3. The one or more computer storage media of any preceding clause, further comprising:
   filter the received plurality of CIV responses using a filter criteria set, wherein the filter criteria set includes at least one filter criterion; and
   wherein determining the target CIV response of the plurality of CIV responses includes determining the CIV response of a filtered plurality of CIV responses that has the most recent last used account timestamp.
C4. The one or more computer storage media of any preceding clause, further comprising:
   prompt the user to select the filter criteria set from a set of possible filter criteria using a criteria selection GUI;
   receive a set of selected criteria from the criteria selection GUI, the set of selected criteria including at least one selected criterion; and
   define the filter criteria set using the received set of selected criteria.
C5. The one or more computer storage media of any preceding clause, wherein the filter criteria set includes at least one of the following:
   a first filter criterion based on transaction types associated with the last used account timestamps,
   a second filter criterion based on merchants associated with the last used account timestamps,
   a third filter criterion based on location data associated with the last used account timestamps, and
   a fourth filter criterion based on available account perks of accounts associated with the last used account timestamps.
C6. The one or more computer storage media of any preceding clause, wherein initiating processing of the payment request further includes:
   displaying information associated with the CIV provider of the determined target CIV response using a GUI;
   prompting the user via a user prompt to confirm use of an account identified by the account identifier associated with the most recent last used account timestamp using the GUI;
   receiving confirmation to use the account from the user using the GUI; and
   completing processing of the payment request using the account confirmed by the user.

Any range or device value given herein may be extended or altered without losing the effect sought, as will be apparent to the skilled person.

Examples have been described with reference to data monitored and/or collected from the users (e.g., user identity data with respect to profiles). In some examples, notice is provided to the users of the collection of the data (e.g., via a dialog box or preference setting) and users are given the opportunity to give or deny consent for the monitoring and/or collection. The consent takes the form of opt-in consent or opt-out consent.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The embodiments illustrated and described herein as well as embodiments not specifically described herein but within the scope of aspects of the claims constitute an exemplary means for receiving, by a processor, a user identifier associated with a payment request from a user; an exemplary means for sending, by the processor, the received user identifier to a plurality of Consumer Identity Validation (CIV) providers; an exemplary means for receiving, by the processor, a plurality of CIV responses from the plurality of CIV providers, wherein each CIV response includes a last used account timestamp; an exemplary means for determining, by the processor, a target CIV response of the plurality of CIV responses that has a most recent last used account timestamp; and an exemplary means for initiating, by the processor, processing of the payment request using a target CIV provider associated with the determined target CIV response and an account identifier associated with the most recent last used account timestamp of the determined target CIV response.

The term “comprising” is used in this specification to mean including the feature(s) or act(s) followed thereafter, without excluding the presence of one or more additional features or acts.

In some examples, the operations illustrated in the figures are implemented as software instructions encoded on a computer readable medium, in hardware programmed or designed to perform the operations, or both. For example, aspects of the disclosure are implemented as a system on a chip or other circuitry including a plurality of interconnected, electrically conductive elements.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system comprising:
at least one processor; and
at least one memory comprising computer program code, the at least one memory and the computer program code configured to, with the at least one processor, cause the at least one processor to:
receive a user identifier associated with a payment request from a user;
send the received user identifier to a plurality of Consumer Identity Validation (CIV) providers;
receive a plurality of CIV responses from the plurality of CIV providers, wherein each CIV response includes a last used account timestamp;
determine a target CIV response of the plurality of CIV responses that has a most recent last used account timestamp; and
initiate processing of the payment request using a target CIV provider associated with the determined target CIV response and an account identifier associated with the most recent last used account timestamp of the determined target CIV response.

2. The system of claim 1, wherein initiating processing of the payment request includes performing a user identity authentication operation.

3. The system of claim 2, wherein the user identity authentication operation includes at least one of the following:
user authentication using a password,
user authentication using a one-time password (OTP),
user authentication using two-factor authentication (2FA), and
user authentication using biometric authentication.

4. The system of claim 1, the at least one memory and the computer program code further configured to, with the at least one processor, cause the at least one processor to:
filter the received plurality of CIV responses using a filter criteria set, wherein the filter criteria set includes at least one filter criterion; and
wherein determining the target CIV response of the plurality of CIV responses includes determining the CIV response of a filtered plurality of CIV responses that has the most recent last used account timestamp.

5. The system of claim 4, the at least one memory and the computer program code further configured to, with the at least one processor, cause the at least one processor to:
prompt the user to select filter criteria set from a set of possible filter criteria using a criteria selection GUI;
receive a set of selected criteria from the criteria selection GUI, the set of selected criteria including at least one selected criterion; and
define the filter criteria set using the received set of selected criteria.

6. The system of claim 4, wherein the filter criteria set includes at least one of the following:
a first filter criterion based on transaction types associated with the last used account timestamps,
a second filter criterion based on merchants associated with the last used account timestamps,
a third filter criterion based on location data associated with the last used account timestamps, and
a fourth filter criterion based on available account perks of accounts associated with the last used account timestamps.

7. The system of claim 1, wherein initiating processing of the payment request further includes:
displaying information associated with the target CIV provider of the determined target CIV response using a GUI;
prompting the user via a user prompt to confirm use of an account identified by the account identifier associated with the most recent last used account timestamp using the GUI;
receiving confirmation to use the account from the user using the GUI; and
completing processing of the payment request using the account confirmed by the user.

8. A computerized method comprising:
receiving, by a processor, a user identifier associated with a payment request from a user;
sending, by the processor, the received user identifier to a plurality of Consumer Identity Validation (CIV) providers;
receiving, by the processor, a plurality of CIV responses from the plurality of CIV providers, wherein each CIV response includes a last used account timestamp;
determining, by the processor, a target CIV response of the plurality of CIV responses that has a most recent last used account timestamp; and
initiating, by the processor, processing of the payment request using a target CIV provider associated with the determined target CIV response and an account identifier associated with the most recent last used account timestamp of the determined target CIV response.

9. The computerized method of claim 8, wherein initiating processing of the payment request includes performing a user identity authentication operation.

10. The computerized method of claim 9, wherein the user identity authentication operation includes at least one of the following:
user authentication using a password,
user authentication using a one-time password (OTP),
user authentication using Two-factor authentication (2FA), and
user authentication using biometric authentication.

11. The computerized method of claim 8, further comprising:
filtering, by the processor, the received plurality of CIV responses using a filter criteria set, wherein the filter criteria set includes at least one filter criterion; and
wherein determining the target CIV response of the plurality of CIV responses includes determining the CIV response of a filtered plurality of CIV responses that has the most recent last used account timestamp.

12. The computerized method of claim 11, further comprising:
prompting, by the processor, the user to select the filter criteria set from a set of possible filter criteria using a criteria selection GUI;
receiving, by the processor, a set of selected criteria from the criteria selection GUI, the set of selected criteria including at least one selected criterion; and
defining, by the processor, the filter criteria set using the received set of selected criteria.

13. The computerized method of claim 11, wherein the filter criteria set includes at least one of the following:
a first filter criterion based on transaction types associated with the last used account timestamps,
a second filter criterion based on merchants associated with the last used account timestamps,
a third filter criterion based on location data associated with the last used account timestamps, and
a fourth filter criterion based on available account perks of accounts associated with the last used account timestamps.

14. The computerized method of claim 8, wherein initiating processing of the payment request further includes:
displaying, by the processor, information associated with the target CIV provider of the determined target CIV response using a GUI;
prompting, by the processor, the user to confirm use of an account identified by the account identifier associated with the most recent last used account timestamp using the GUI;
receiving, by the processor, confirmation to use the account from the user using the GUI; and
completing, by the processor, processing of the payment request using the account confirmed by the user.

15. One or more computer storage media having computer-executable instructions that, upon execution by a processor, cause the processor to at least:
receive a user identifier associated with a payment request from a user;
send the received user identifier to a plurality of Consumer Identity Validation (CIV) providers;
receive a plurality of CIV responses from the plurality of CIV providers, wherein each CIV response includes a last used account timestamp;
determine a target CIV response of the plurality of CIV responses that has a most recent last used account timestamp; and
initiate processing of the payment request using a target CIV provider associated with the determined target CIV response and an account identifier associated with the most recent last used account timestamp of the determined target CIV response.

16. The one or more computer storage media of claim 15, wherein initiating processing of the payment request includes performing a user identity authentication operation, the user identity authentication operation comprising at least one of the following:
user authentication using a password,
user authentication using a one-time password (OTP),
user authentication using two-factor authentication (2FA), and
user authentication using biometric authentication.

17. The one or more computer storage media of claim 15, further comprising:
filter the received plurality of CIV responses using a filter criteria set, wherein the filter criteria set includes at least one filter criterion; and
wherein determining the target CIV response of the plurality of CIV responses includes determining the CIV response of a filtered plurality of CIV responses that has the most recent last used account timestamp.

18. The one or more computer storage media of claim 17, further comprising:
prompt the user to select the filter criteria set from a set of possible filter criteria using a criteria selection GUI;
receive a set of selected criteria from the criteria selection GUI, the set of selected criteria including at least one selected criterion; and
define the filter criteria set using the received set of selected criteria.

19. The one or more computer storage media of claim 17, wherein the filter criteria set includes at least one of the following:
a first filter criterion based on transaction types associated with the last used account timestamps,
a second filter criterion based on merchants associated with the last used account timestamps,
a third filter criterion based on location data associated with the last used account timestamps, and
a fourth filter criterion based on available account perks of accounts associated with the last used account timestamps.

20. The one or more computer storage media of claim 15, wherein initiating processing of the payment request further includes:
displaying information associated with the CIV provider of the determined target CIV response using a GUI;
prompting the user via a user prompt to confirm use of an account identified by the account identifier associated with the most recent last used account timestamp using the GUI;
receiving confirmation to use the account from the user using the GUI; and
completing processing of the payment request using the account confirmed by the user.
